(19) United States
(12) Patent Application Publication
(10) Pub. No.: US 2019/0393505 A1
(43) Pub. Date: Dec. 26, 2019

(54) ALL-SOLID-STATE BATTERY, ELECTRONIC DEVICE, ELECTRONIC CARD, WEARABLE DEVICE, AND ELECTRIC MOTOR VEHICLE

(71) Applicant: Murata Manufacturing Co., Ltd., Nagaokakyo-shi (JP)

(72) Inventors: Masamitsu Suzuki, Nagaokakyo-shi (JP); Keisuke Shimizu, Nagaokakyo-shi (JP); Tomohiro Kato, Nagaokakyo-shi (JP); Norio Fukasawa, Nagaokakyo-shi (JP); Motokazu Ishihara, Nagaokakyo-shi (JP)

(21) Appl. No.: 16/552,104

(22) Filed: Aug. 27, 2019

Related U.S. Application Data
(63) Continuation of application No. PCT/JP2017/042252, filed on Nov. 24, 2017.

(30) Foreign Application Priority Data
Mar. 28, 2017 (JP) 2017-063716

(51) Int. Cl. H01M 4/587; H01M 4/66; H01M 10/0585

(52) U.S. Cl. CPC H01M 4/587; H01M 4/666; H01M 2004/027; H01M 4/663; H01M 10/0585; H01M 4/661

(57) ABSTRACT

An all-solid-state battery that includes a cathode layer, an anode layer, and a solid electrolyte layer between the cathode layer and the anode layer. The anode layer contains a carbon material, and a volume occupancy of the carbon material in the anode layer is 50 vol % to 95 vol %.

### CROSS REFERENCE TO RELATED APPLICATIONS

The present application is a continuation of International application No. PCT/JP2017/042252, filed Nov. 24, 2017, which claims priority to Japanese Patent Application No. 2017-063716, filed Mar. 28, 2017, the entire contents of each of which are incorporated herein by reference.

### FIELD OF THE INVENTION

The present technology relates to an all-solid-state battery, an electronic device, an electronic card, a wearable device, and an electric motor vehicle.

### BACKGROUND OF THE INVENTION

In general, a lithium ion secondary battery or a lithium ion polymer secondary battery is produced as follows. First, a current collector foil of metals (Cu, Al, Ni, and the like) is used as a substrate, and a paint is coated on the current collector foil and dried to form an electrode active material layer. Subsequently, the electrodes thus obtained are cut and stacked with a separator interposed therebetween to form a battery.

On the other hand, an all-solid-state battery using an oxide-based solid electrolyte is produced using a green sheet as follows in some cases (see, for example, Patent Document 1). A solid electrolyte layer, a current collecting layer, an electrode active material layer and the like are all produced as green sheets in a coating process, and then the green sheets are laminated, cut, and then sintered to form a battery.

Various methods of forming a current collecting layer are under consideration in a multi-layer ceramic capacitor (MLCC). For example, Patent Document 2 proposes a technique for forming a current collecting layer (internal electrode layer) using metal grains (see, for example, Patent Document 2).

Patent Document 1: Japanese Patent Application Laid-Open No. 2016-192370

Patent Document 2: Japanese Patent Application Laid-Open No. 2011-150982

### SUMMARY OF THE INVENTION

However, when the current collecting layer using metal grains is used for the all-solid-state battery, a metal oxide film is formed on a surface of the current collecting layer or the metal grains in the sintering step, and when the oxide film is reduced on an anode which is at a low potential, there is a possibility that an irreversible capacity increases.

An object of the present technology is to provide an all-solid-state battery capable of suppressing an irreversible capacity, an electronic device provided with the same, an electronic card, a wearable device, and an electric motor vehicle.

In order to solve the above problems, a first technology relates to an all-solid-stage battery including a cathode layer, an anode layer, and a solid electrolyte layer between the cathode layer and the anode layer, and in which the anode layer contains a carbon material, and a volume occupancy of the carbon material in the anode layer is 50 vol % to 95 vol %.

A second technology relates to an electronic device which is supplied with power from the all-solid-state battery of the first technology.

A third technology relates to an electronic card which is supplied with power from the all-solid-state battery of the first technology.

A fourth technology relates to a wearable device which is supplied with power from the all-solid-state battery of the first technology.

A fifth technology relates to an electric motor vehicle including the all-solid-state battery of the first technology, a conversion device which is supplied with power from the all-solid-state battery and converts the power into a driving force of a vehicle, and a control device which processes vehicle control information based on information regarding the all-solid-state battery.

According to the present technology, the irreversible capacity of the all-solid-state battery can be suppressed. Note that the effects described herein are not necessarily limited, and may be any of the effects described in the present disclosure or effects different therefrom.

### BRIEF EXPLANATION OF THE DRAWINGS

FIG. 1A is a perspective view illustrating an example of an appearance of a battery according to a first embodiment of the present technology. FIG. 1B is a cross-sectional view taken along the line IB-IB of FIG. 1A.

FIG. 2 is an exploded perspective view illustrating an example of a configuration of a battery according to the first embodiment of the present technology.

FIG. 3 is a cross-sectional view illustrating an example of a configuration of a battery according to a modified example of the first embodiment of the present technology.

FIG. 4 is a cross-sectional view illustrating an example of a configuration of a battery according to a modified example of the first embodiment of the present technology.

FIG. 5 is a cross-sectional view illustrating an example of a configuration of a battery according to a second embodiment of the present technology.

FIG. 6 is an exploded perspective view illustrating an example of a configuration of a battery according to the second embodiment of the present technology.

FIGS. 7A and 7B each are graphs illustrating the relationship between a volume ratio (A:B) of a conductive material (or electrode material) A and glass B, and the relationship of volume resistivity.

FIGS. 8A and 8B each are cross-sectional views illustrating configurations of batteries of samples 3-1 and 3-2, respectively.

FIG. 9 is a graph illustrating charge and discharge curves of the batteries of samples 3-1 and 3-2.

FIG. 10A is a graph illustrating impedance curves of the batteries of the samples 3-1 and 3-2. FIG. 10B is an enlarged graph of a part of FIG. 10A.

FIG. 11 is a graph illustrating impedance curves of a sample 4-1.

FIG. 12A is a graph illustrating charge and discharge curves of batteries of samples 5-1 and 5-2. FIG. 12B is a graph illustrating impedance curves of the samples 5-1 and 5-2.

FIG. 13 is a perspective view illustrating an example of a configuration of a printed circuit board as an application example.

FIG. 14 is a plan view illustrating an example of an appearance of a universal credit card as an application example.

FIG. 15 is a block diagram of an example of a configuration of a wireless sensor node as an application example.

FIG. 16 is a perspective view illustrating an example of an appearance of a wristband type electronic device as an application example.

FIG. 17 is a block diagram illustrating an example of the configuration of the wristband type electronic device as an application example.

FIG. 18 is a perspective view illustrating an example of an overall configuration of a smart watch as an application example.

FIG. 19 is a block diagram illustrating an example of a circuit configuration of the smart watch as an application example.

FIG. 20 is a perspective view illustrating an example of an appearance of a glasses type terminal as an application example.

FIG. 21 is a conceptual diagram of an example of a configuration of an image display device of the glasses type terminal as an application example.

FIG. 22 is a schematic diagram illustrating an example of a configuration of a storage system of a vehicle as an application example.

FIG. 23 is a schematic diagram illustrating an example of a configuration of a storage system of a house as an application example.

### DETAILED DESCRIPTION OF THE INVENTION

Embodiments, examples, and application examples of the present technology will be described in the following procedure.

1 First embodiment (example of all-solid-state battery)

2 Second embodiment (example of all-solid-state battery)

3 Example

4 Application example

### 1 First Embodiment

[Configuration of Battery]

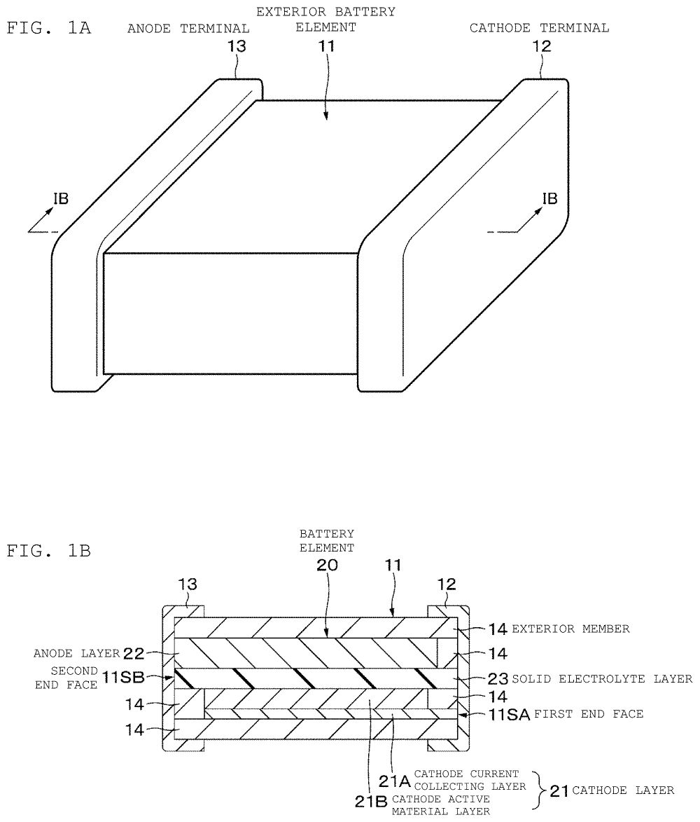

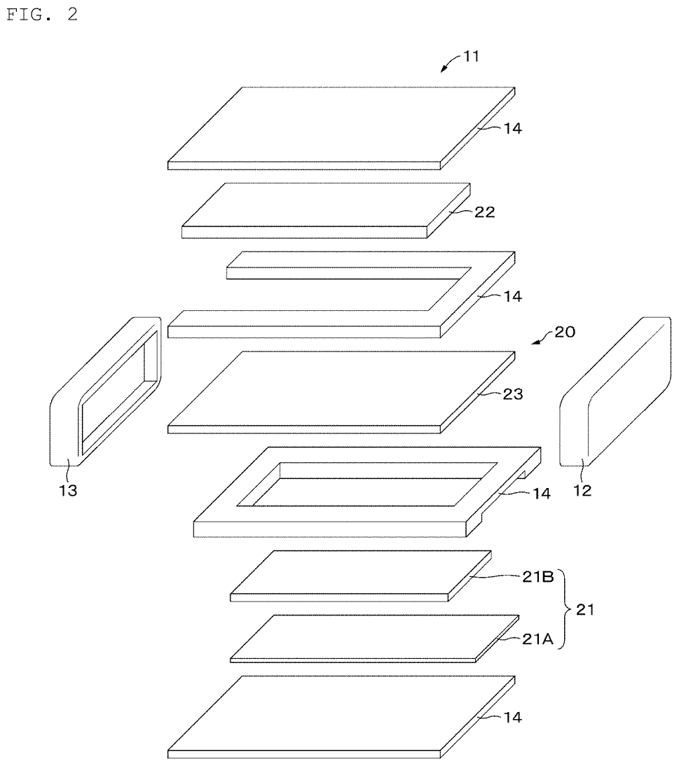

A battery according to a first embodiment of the present technology is a so-called bulk type all-solid-state battery, and as illustrated in FIGS. 1A, 1B, and 2, includes a thin plate-like exterior battery element 11 having a first end face 11SA and a second end face 11SB facing the first end face 11SA, a cathode terminal 12 provided on the first end face 11SA, and an anode terminal 13 provided on the second end face 11SB. In the first embodiment, a case where a main surface of the exterior battery element 11 has a quadrangular shape will be described, but the shape of the main surface of the exterior battery element 11 is not limited thereto.

This battery is a secondary battery in which a battery capacity is repeatedly obtained by transferring Li which is an electrode reactant, and may be a lithium ion secondary battery in which a capacity of an anode is obtained by occluding and releasing lithium ions and may be a lithium metal secondary battery in which a capacity of an anode can be obtained by precipitating and dissolving lithium metal.

(Cathode Terminal and Anode Terminal)

A cathode terminal and an anode terminal 12 and 13 contain a conductive material. The conductive material includes, for example, a powder of conductive grains. The conductive grains may be sintered. The cathode terminal and the anode terminal 12 and 13 may further contain glass or glass ceramics as needed. The glass or the glass ceramics may be sintered.

It is preferable that a glass transition temperature of the glass contained in the cathode terminal and the anode terminal 12 and 13 be equal to or lower than a sintering temperature of an exterior member 14. If the glass transition temperature is equal to or lower than the sintering temperature of the exterior member 14, the cathode terminal and the anode terminal 12 and 13 can be sintered simultaneously when the exterior member 14 is sintered

Examples of the shape of the conductive grains include, for example, a spherical shape, an oval shape, a needle shape, a plate shape, a scaly shape, a tube shape, a wire shape, a rod shape, and an irregular shape or the like, but are not particularly limited thereto. Note that two or more grains having the above-mentioned shapes may be combined.

The conductive material is, for example, at least one of a metal material, a metal oxide material, and a carbon material. Specifically, the conductive material includes, for example, at least one conductive grain of metal grains, metal oxide grains and carbon grains. Here, metal is defined as containing metalloid. Examples of the metal material include at least one of silver (Ag), platinum (Pt), gold (Au), nickel (Ni), copper (Cu), palladium (Pd), aluminum (Al), and iron (Fe), but are not limited thereto.

Examples of the metal oxide material include indium tin oxide (ITO), zinc oxide, indium oxide, antimony-added tin oxide, fluorine-added tin oxide, aluminum-added zinc oxide, gallium-added zinc oxide, silicon-added zinc oxide, a zinc oxide-tin oxide type, an indium oxide-tin oxide type, a zinc oxide-indium oxide-magnesium oxide type and the like, but are not limited thereto.

Examples of the carbon material include carbon black, porous carbon, carbon fiber, fullerene, graphene, carbon nanotube, carbon micro coil, nano horn, or the like, but are not limited thereto. The glass is, for example, oxide glass. The glass ceramics is, for example, oxide glass ceramics.

(Exterior Battery Element)

As illustrated in FIGS. 1A, 1B, and 2, an exterior battery element 11 includes a laminated battery element 20 and an exterior member 14 that covers a surface of the battery element 20.

(Battery Element)

The battery element 20 is a laminate including a cathode layer 21 having a two-layer structure, an anode layer 22 having a single-layer structure, and a solid electrolyte layer 23 provided between the cathode layer 21 and the anode layer 22. The cathode layer 21 includes a cathode current collecting layer 21A and a cathode active material layer 21B which is provided on a main surface of a side facing the anode layer 22, among both main surfaces of the cathode current collecting layer 21A.

(Exterior Member)

As illustrated in FIGS. 1B and 2, an exterior member 14 covers a surface of the battery element 20 so that one end of the cathode current collecting layer 21A is exposed from the first end face 11SA, one end of the anode layer 22 is exposed from the second end face 11SB, and a peripheral portion of the solid electrolyte layer 23 is exposed from the entire end face of the exterior battery element 11. Note that the exterior member 14 may cover the surface of the battery element 20 so that the peripheral portion of the solid electrolyte layer 23 is not exposed from the entire end face of the exterior battery element 11.

The exterior member 14 contains oxide glass or oxide glass ceramics. It is possible to suppress moisture from permeating into the battery element 20 by covering the surface of the battery element 20 with the exterior member 14 containing such a material. Therefore, the atmospheric stability of the all-solid-state battery can be improved.

The exterior member 14 may further contain crystal grains. When the exterior member 14 further includes crystal grains, a contraction of the exterior member 14 is suppressed in a firing step of the exterior member 14 (at the time of cooling after firing, and the like), and a difference in a contraction ratio between the battery element 20 and the exterior member 14 can be reduced. Therefore, it is possible to suppress distortion and cracking of the exterior member 14 in the firing step of the exterior member 14.

Examples of the oxide glass and the oxide glass ceramics contain at least one of boron (B), bismuth (Bi), tellurium (Te), phosphorus (P), vanadium (V), tin (Sn), lead (Pb), and silicon (Si). More specifically, the oxide glass and the oxide ceramics are an oxide containing at least one of B, Bi, Te, P, V, Sn, Pb, and Si.

The exterior member 14 may contain a solid electrolyte. As the solid electrolyte, those similar to the solid electrolyte contained in the solid electrolyte layer 23 can be exemplified. Note that the solid electrolyte contained in the solid electrolyte layer 23 will be described below. A composition (type of material) or a composition ratio of the solid electrolyte contained in the solid electrolyte layer 23 and the exterior member 14 may be the same or different.

The crystal grains contain at least one of metal oxide, metal nitride, and metal carbide. Here, metal is defined as containing metalloid. More specifically, the crystal grain contain at least one of aluminum oxide:alumina (Al₂O₃), silicon oxide:quartz (SiO₂), silicon nitride (SiN), aluminum nitride (AlN), and silicon carbide (SiC).

A moisture permeability of the exterior member 14 is preferably 1 g/m²/day or less, more preferably 0.75 g/m²/day or less, and still more preferably 0.5 g/m²/day or less from the viewpoint of improving the atmospheric stability of the all-solid-state battery. The moisture permeability of the exterior member 14 described above is obtained as follows. First, a part of the exterior member 14 is extracted as a rectangular plate-like small piece from the all-solid-state battery element by ion milling, polishing or the like. Next, a water vapor transmission rate (23° C., 90% RH) of the exterior member 14 is measured in accordance with JIS K 7129-C (ISO 15106-4).

A Li ion conductivity of the exterior member 14 is preferably 1×10⁻⁸ S/cm or less from the viewpoint of suppressing a self-discharge of the all-solid-state battery. The Li ion conductivity of the exterior member 14 is determined by an AC impedance method as follows. First, a part of the exterior member 14 is extracted as a rectangular plate-like small piece from the all-solid-state battery element by the ion milling, the polishing or the like. Next, an electrode made of gold (Au) is formed on both end portions of the small piece extracted to produce a sample. Next, AC impedance measurement (frequency: 10⁺⁶ Hz to 10⁻¹ Hz, voltage: 100 mV, 1000 mV) is performed on the sample at room temperature (25° C.) using an impedance measuring device (manufactured by Toyo Technica Co. Ltd.), and a Cole-Cole plot is created. Subsequently, the ion conductivity is determined from the Cole-Cole plot.

An electrical conductivity (electron conductivity) of the exterior member 14 is preferably 1×10⁻⁸ S/cm or less from the viewpoint of suppressing the self-discharge of the all-solid-state battery. The electrical conductivity of the exterior member 14 described above is obtained as follows. First, the sample is produced in the same manner as the above-mentioned method of measuring the Li ion conductivity. Next, the electrical conductivity is determined at room temperature (25° C.) by a two-terminal method using the produced sample.

An average thickness of the exterior member 14 is preferably 50 μm or less, more preferably 40 μm or less, and still more preferably 30 μm or less, from the viewpoint of improving an energy density of the all-solid-state battery. The average thickness of the exterior member 14 described above is obtained as follows. First, a cross section of the exterior member 14 is produced by the ion milling or the like, and a cross sectional scanning electron microscope (SEM) image is shot. Next, 10 points are randomly selected from this cross-sectional SEM image, the thickness of the exterior member 14 is measured at each point, and these measured values are simply averaged (arithmetic average) to obtain the average thickness of the exterior member 14.

(Solid Electrolyte Layer)

The solid electrolyte layer 23 contains a solid electrolyte. The solid electrolyte is at least one of the oxide glass and the oxide glass ceramics which are lithium ion conductors, and is preferably the oxide glass ceramics from the viewpoint of improving the Li ion conductivity. When the solid electrolyte is at least one of the oxide glass and the oxide glass ceramics, the stability of the solid electrolyte layer 23 with respect to the atmospheric air (moisture) can be improved. The solid electrolyte layer 23 is, for example, a sintered body of a green sheet as a solid electrolyte layer precursor.

Here, the glass refers to crystallographically amorphous materials such as a halo observed by X-ray diffraction, electron beam diffraction and the like. The glass ceramics (crystallized glass) refers to crystallographically mixed amorphous and crystalline materials, such as peaks and halos observed by the X-ray diffraction, the electron beam diffraction, and the like.

The Li ion conductivity of the solid electrolyte is preferably 10⁻⁷ S/cm or more from the viewpoint of improving the battery performance. The Li ion conductivity of the solid electrolyte can be obtained in the same manner as the method of measuring Li ion conductivity of the above-mentioned exterior member 14 except that the solid electrolyte layer 23 is extracted from the all-solid-state battery element by the ion milling, the polishing or the like and the measurement sample is produced using the extracted solid electrolyte layer 23.

The solid electrolyte contained in the solid electrolyte layer 23 is sintered. The sintering temperature of the oxide glass and the oxide glass ceramics which are the solid electrolyte is preferably 550° C. or lower, more preferably 300° C. or higher and 550° C. or lower, and still more preferably 300° C. or higher and 500° C. or lower.

When the sintering temperature is 550° C. or lower, the carbon material is prevented from being burned down in the sintering step, and therefore, the carbon material can be used as the anode active material. Therefore, the energy density of the battery can be further improved. In addition, when the cathode active material layer 21B contains a conductive agent, the carbon material can be used as the conductive agent. Therefore, a favorable electron conduction path can be formed in the cathode active material layer 21B, and the conductivity of the cathode active material layer 21B can be improved. Even when the anode layer 22 contains a conductive agent, the carbon material can be used as the conductive agent, such that the conductivity of the anode layer 22 can be improved.

In addition, when the sintering temperature is 550° C. or lower, the solid electrolyte reacts with the electrode active material in the sintering step to be able to suppress byproducts such as a passivation from being formed. Therefore, the deterioration in the battery characteristics can be suppressed. In addition, if the sintering temperature is a low temperature of 550° C. or lower, the selection range of the type of electrode active material is expanded, such that the degree of freedom in the battery design can be improved.

On the other hand, when the sintering temperature is 300° C. or higher, a general organic binder such as an acrylic resin contained in the electrode precursor and/or the solid electrolyte layer precursor can be burned down in the sintering step.

The oxide glass and the oxide glass ceramics each are Li-containing oxide glass and Li-containing oxide glass-ceramics. It is preferable that the Li-containing oxide glass and the Li-containing oxide glass ceramics have a sintering temperature of 550° C. or lower, have a high thermal contraction rate, and are rich in fluidity. This is because the following effects can be obtained. That is, the reaction between the solid electrolyte layer 23 and the cathode active material layer 21B and the reaction between the solid electrolyte layer 23 and the anode layer 22 can be suppressed. In addition, good interfaces are formed between the cathode active material layer 21B and the solid electrolyte layer 23, and between the anode layer 22 and the solid electrolyte layer 23, and an interface resistance between the cathode active material layer 21B and the solid electrolyte layer 23 and between the anode layer 22 and the solid electrolyte layer 23 can be reduced.

The oxide glass and the oxide glass ceramics preferably contain at least one of germanium (Ge), silicon (Si), boron (B) and phosphorus (P), lithium (Li), and oxygen (O), and more preferably contain Si, B, Li, and O. Specifically, the oxide glass and the oxide glass ceramics preferably contain at least one of germanium oxide (GeO₂), silicon oxide (SiO₂), boron oxide (B₂O₃), and phosphorus oxide (P₂O₅), and lithium oxide (Li₂O), and more preferably contain SiO₂, B₂O₃, and Li₂O. As described above, since the oxide glass and the oxide glass-ceramics containing at least one of Ge, Si, B, and P, Li, and O have a sintering temperature of 300° C. or higher and 550° C. or lower, have a high thermal contraction rate and is also rich in fluidity, it is advantageous from the viewpoint of reducing the interface resistance, improving the energy density of the battery, and the like.

The content of Li₂O is preferably 20 mol % to 75 mol %, more preferably 30 mol % or more and 75 mol % or less, still more preferably 40 mol % or more and 75 mol % or less, and particularly preferably 50 mol % or more and 75 mol % or less from the viewpoint of lowering the sintering temperature of the solid electrolyte.

When the solid electrolyte contains GeO₂, the content of GeO₂ is preferably more than 0 mol % and 80 mol % or less. When the solid electrolyte contains SiO₂, the content of SiO₂ is preferably more than 0 mol % and 70 mol % or less. When the solid electrolyte contains B₂O₃, the content of B₂O₃ is preferably more than 0 mol % and 60 mol % or less. When the solid electrolyte contains P₂O₅, the content of P₂O₅ is preferably more than 0 mol % and 50 mol % or less.

The content of each oxide is the content of each oxide in the solid electrolyte, and specifically, a ratio of the content (mol) of each oxide to the total amount (mol) of at least one of GeO₂, SiO₂, B₂O₃, and P₂O₅, and Li₂O is shown in percentage units (mol %). The content of each oxide can be measured using inductively coupled plasma emission spectrometry (ICP-AES) or the like.

The solid electrolyte may further contain an additive element as needed. Examples of the additional element contain at least one selected from the group consisting of sodium (Na), magnesium (Mg), aluminum (Al), potassium (K), calcium (Ca), titanium (Ti), vanadium (V), chromium (Cr), manganese (Mn), iron (Fe), cobalt (Co), nickel (Ni), copper (Cu), zinc (Zn), gallium (Ga), selenium (Se), rubidium (Rb), sulfur (S), yttrium (Y), zirconium (Zr), niobium (Nb), molybdenum (Mo), silver (Ag), indium (In), tin (Sn), antimony (Sb), cesium (Cs), barium (Ba), hafnium (Hf), tantalum (Ta), tungsten (W), lead (Pb), bismuth (Bi), gold (Au), lanthanum (La), neodymium (Nd), and europium (Eu). The solid electrolyte may contain at least one selected from the group consisting of these additive elements as oxide.

(Cathode Current Collecting Layer)

The cathode current collecting layer 21A contains a conductive material and a solid electrolyte. The solid electrolyte may have a function as a binder. The conductive material includes a powder of conductive grains. The conductive material includes, for example, at least one of a carbon material and a metal material, and preferably includes the carbon material. Since the carbon material is softer than the metal material, a favorable interface can be formed between the cathode current collecting layer 21A and the cathode active material layer 21B. Therefore, the interface resistance between the cathode current collecting layer 21A and the cathode active material layer 21B can be reduced. In addition, since the carbon material is less expensive than the metal material, the production cost of the battery can be reduced.

As the carbon material, for example, at least one of graphite, carbon fiber, carbon black, carbon nanotube and the like can be used. As the carbon fiber, for example, vapor growth carbon fiber (VGCF) or the like can be used. As the carbon black, for example, at least one of acetylene black and ketjen black can be used. As the carbon nanotube, for example, single wall carbon nanotube (SWCNT) and multi-wall carbon nanotube (MWCNT) such as double wall carbon nanotube (DWCNT) and the like can be used. As the metal material, for example, metal grain powder, such as Ni grain powder, can be used. However, the conductive material is not particularly limited to those described above.

As the solid electrolyte, those similar to the solid electrolyte contained in the solid electrolyte layer 23 can be exemplified. However, a composition (type of material) or a composition ratio of the solid electrolyte contained in the solid electrolyte layer 23 and the cathode current collecting layer 21A may be the same or different.

When the cathode current collecting layer 21A contains a carbon material as a conductive material, the volume occupancy of the carbon material in the cathode current collecting layer 21A is preferably 50 vol % or more and 95 vol % or less. If the volume occupancy is less than 50 vol %, there is a possibility that the electrical conductivity of the cathode current collecting layer 21A is reduced. On the other hand, if the volume occupancy exceeds 95 vol %, the volume occupancy of the solid electrolyte in the cathode current collecting layer 21A is too small, such that there is a possibility that the strength of the cathode current collecting layer 21A is reduced.

The electrical conductivity of the carbon material described above is obtained as follows. First, after the battery is fully discharged, the following process is performed at 10 points randomly selected from the battery. That is, a cross section of the battery is produced by the ion milling or the like, and a procedure of shooting the cross sectional SEM image of the cathode current collecting layer 21A is repeated to acquire a three-dimensional SEM image. The volume occupancy of a carbon material is obtained from the acquired three-dimensional SEM image. Next, the volume occupancy of the carbon material obtained at 10 points as described above is simply averaged (arithmetically averaged) and thus becomes the volume occupancy (vol %) of the carbon material in the cathode current collecting layer 21A.

The cathode current collecting layer 21A may be, for example, a metal layer containing Al, Ni, stainless steel or the like. The shape of the metal layer is, for example, a foil shape, a plate shape, or a mesh shape.

(Cathode Active Material Layer)

The cathode active material layer 21B contains a cathode active material and a solid electrolyte. The solid electrolyte may have a function as a binder. The cathode active material layer 21B may further contain a conductive agent as needed.

The cathode active material includes, for example, a cathode material capable of occluding and releasing lithium ions which are an electrode reactant. The cathode material is preferably a lithium-containing compound or the like from the viewpoint of obtaining the high energy density, but is not limited thereto. The lithium-containing compound includes, for example, complex oxide (lithium transition metal complex oxide) containing lithium and a transition metal element as a constituent element, a phosphate compound (lithium transition metal phosphate compound) containing lithium and a transition metal element as a constituent element, or the like. Among those, the transition metal element is preferably one or more of Co, Ni, Mn, and Fe. As a result, when a higher voltage is obtained and the voltage of the battery can be increased, energy (Wh) of the battery having the same capacity (mAh) can be increased.

The lithium transition metal complex oxide is, for example, one represented by LiₓM1O₂ or Li_{y}M2O₄, or the like. More specifically, for example, the lithium transition metal complex oxide is LiCoO₂, LiNiO₂, LiVO₂, LiCrO₂, LiMn₂O₄, or the like. In addition, the lithium transition metal phosphate compound is, for example, one represented by Li_{z}M3PO₄ or the like. More specifically, for example, the lithium transition metal phosphate compound is LiFePO₄ or LiCoPO₄ or the like. However, M1 to M3 are one or more transition metal elements, and values of x to z are optional.

In addition, examples of the cathode active material may include be, for example, oxide, disulfide, chalcogenide, and a conductive polymer. Examples of the oxide include titanium oxide, vanadium oxide, manganese dioxide and the like. Examples of the disulfide include titanium disulfide, molybdenum sulfide and the like. Examples of the chalcogenide include niobium selenide and the like. Examples of the conductive polymer include disulfide, polypyrrole, polyaniline, polythiophene, polyparastyrene, polyacetylene, polyacene and the like.

As the solid electrolyte, those similar to the solid electrolyte contained in the solid electrolyte layer 23 can be exemplified. However, the composition (type of material) or the composition ratio of the solid electrolyte contained in the solid electrolyte layer 23 and the cathode active material layer 21B may be the same or different.

Examples of the conductive agent contain at least one of the carbon material and the metal material. As the carbon material and the metal material, those similar to the carbon material and the metal material which are contained in the cathode current collecting layer 21A can be exemplified.

(Anode Layer)

The anode layer 22 has functions of both the anode active material layer and the anode current collecting layer. The anode layer 22 contains an anode material and a solid electrolyte. The solid electrolyte may have a function as a binder. The anode layer 22 may further contain a conductive agent as needed.

The anode material has functions of both the anode active material and the conductive agent. Specifically, the anode material can occlude and release lithium ions which are electrode reactants, and has electrical conductivity. The anode material having such a function contains a carbon material. The anode material may further contain a metal-based material in addition to the carbon material. The carbon material preferably contains at least one of graphite, acetylene black, ketjen black, and carbon fiber from the viewpoint of obtaining the high energy density and the high electrical conductivity, and among these carbon materials, the graphite is particularly preferred.

The volume occupancy of the carbon material in the anode layer 22 is 50 vol % to 95 vol %. If the volume occupancy is less than 50 vol %, there is a possibility that the energy density and the electrical conductivity of the anode layer 22 are reduced. On the other hand, if the volume occupancy rate exceeds 95 vol %, the volume occupancy of the solid electrolyte in the anode layer 22 is too small, such that there is a possibility that the strength of the anode layer 22 is reduced.

The electrical conductivity of the carbon material described above is obtained as follows. First, after the battery is fully discharged, the following process is performed at 10 points randomly selected from the battery. That is, the cross section of the battery is produced by the ion milling or the like, and a procedure of shooting the cross sectional SEM image of the anode layer 22 is repeated to acquire a three-dimensional SEM image. The volume occupancy of a carbon material is obtained from the acquired three-dimensional SEM image. Subsequently, the volume occupancy of the carbon material obtained at 10 points as described above is simply averaged (arithmetically averaged) and thus becomes the volume occupancy (vol %) of the carbon material in the anode layer 22.

The metal-based material is, for example, a material containing a metal element or a metalloid element capable of forming an alloy with lithium as a constituent element. More specifically, examples of the metal-based material include a simple substance such as silicon (Si), tin (Sn), aluminum (Al), indium (In), magnesium (Mg), boron (B), gallium (Ga), germanium (Ge), lead (Pb), bismuth (Bi), cadmium (Cd), silver (Ag), zinc (Zn), hafnium (Hf), zirconium (Zr), yttrium (Y), palladium (Pd), platinum (Pt) or the like, or one or more of alloys or compounds. However, the simple substance is not limited to the purity of 100%, and may contain a trace amount of impurities. Examples of the alloy or the compound include SiB₄, TiSi₂, SiC, Si₃N₄, SiOᵥ (0<v≤2), LiSiO, SnO_{w} (0<w≤2), SnSiO₃, LiSnO, Mg₂Sn, and the like.

The metal-based material may be a lithium-containing compound or lithium metal (simple substance of lithium). The lithium-containing compound is composite oxide (lithium transition metal composite oxide) containing lithium and a transition metal element as constituent elements. Examples of the composite oxide include Li₄Ti₆O₁₂, and the like.

The solid electrolyte is preferably at least one of Li-containing oxide glass and Li-containing oxide glass ceramics, and the Li-containing oxide glass ceramic is particularly preferable from the viewpoint of improvement of Li ion conductivity. When the solid electrolyte is at least one of the Li-containing oxide glass and the Li-containing oxide glass ceramics, the oxide glass and the oxide glass ceramics can be reduced to suppress occurrence of an irreversible capacity.

As the Li-containing oxide glass and the Li-containing oxide glass ceramics, from the viewpoint of suppressing the occurrence of the irreversible capacity, the Li-containing oxide glass and the Li-containing oxide glass ceramics exemplified in the above-mentioned solid electrolyte layer 23 are preferable. A composition (type of material) or a composition ratio of the solid electrolyte contained in the solid electrolyte layer 23 and the anode layer 22 may be the same or different.

Examples of the conductive agent contain at least one of the carbon material and the metal material. As the carbon material and the metal material, those similar to the carbon material and the metal material which are contained in the cathode current collecting layer 21A can be exemplified. When the conductive agent contains a metal material, from the viewpoint of suppressing the occurrence of the irreversible capacity, the volume ratio of the metal material to the carbon material (metal material/carbon material) is preferably 0.5 or less, more preferably 0.3 or less, still more preferably 0.1 or less, and particularly preferably 0.05 or less.

[Operation of Battery]

In this battery, for example, the lithium ions released from the cathode active material layer 21B are incorporated into the anode layer 22 via the solid electrolyte layer 23 during charging, and lithium ions released from the anode layer 22 are incorporated into the cathode active material layer 21B via the solid electrolyte layer 23 during discharging.

[Method of Producing Battery]

Hereinafter, an example of a method of producing a battery according to the first embodiment of the present technology will be described.

(Step of Preparing Paste for Forming Solid Electrolyte Layer)

After a solid electrolyte and an organic-based binder are mixed to prepare a mixture powder, the mixture powder is dispersed in a solvent to obtain a paste for forming a solid electrolyte layer.

As the organic-based binder, for example, an acrylic resin can be used. The solvent is not particularly limited as long as it can disperse the mixture powder, but it is preferable that the solvent be burned down in a temperature range lower than a sintering temperature of the paste for forming the solid electrolyte layer. As the solvent, for example, lower alcohols having 4 or less carbon atoms such as methanol, ethanol, isopropanol, n-butanol, sec-butanol, and t-butanol, aliphatic glycols such as ethylene glycol, propylene glycol (1,3-propanediol), 1,3-propanediol, 1,4-butanediol, 1,2-butanediol, 1,3-butanediol, and 2-methyl-1,3-propanediol, ketones such as methyl ethyl ketone, amines such as dimethylethylamine, alicyclic alcohols such as terpineol, and the like can be used alone or in a combination of two or more thereof, but the solvent is not particularly limited thereto. Examples of the dispersion method include stirring processing, ultrasonic dispersion processing, bead dispersion processing, kneading processing, homogenizer processing, and the like. Even in a step of preparing a paste for forming a cathode current collecting layer, a paste for forming a cathode active material layer, a paste for forming an anode layer, a paste for forming an exterior member, and a conductive paste described below, as the organic-based binder and the solvent, the same material as the paste for forming the solid electrolyte layer can be exemplified.

(Step of Preparing Paste for Forming Cathode Current Collecting Layer)

After a powder of conductive grains, a solid electrolyte, and an organic-based binder are mixed to prepare a mixture powder, the mixture powder is dispersed in a solvent to obtain a paste for forming a cathode current collecting layer.

(Step of Preparing Paste for Forming Cathode Active Material Layer)

After a cathode active material, a solid electrolyte, an organic-based binder, and if necessary, a conductive agent are mixed to prepare a mixture powder, the mixture powder is dispersed in a solvent to obtain a paste for forming a cathode active material layer.

(Step of Preparing Paste for Forming Anode Layer)

After an anode material, a solid electrolyte, an organic-based binder, and if necessary, a conductive agent are mixed to prepare a mixture powder, the mixture powder is dispersed in a solvent to obtain a paste for forming an anode layer.

(Step of Preparing Paste for Forming Exterior Member)

After a solid electrolyte, an organic-based binder, and if necessary, a powder of crystal grains are mixed to prepare a mixture powder, the mixture powder is dispersed in a solvent to obtain a paste for forming an exterior member.

(Step of Preparing Conductive Paste)

After a powder of conductive grains, glass or glass ceramics, and an organic-based binder are mixed to prepare a mixture powder, the mixture powder is dispersed in a solvent to obtain a conductive paste for forming a cathode terminal and an anode terminal.

(Step of Producing Solid Electrolyte Layer)

First, a paste layer is formed by uniformly coating or printing a paste for forming a solid electrolyte on a surface of a support substrate. As the support substrate, for example, polymeric resin films such as a polyethylene terephthalate (PET) film can be used. As the coating and printing methods, it is preferable to use a method which is simple and suitable for mass production. As the coating method, for example, a die coating method, a microgravure coating method, a wire bar coating method, a direct gravure coating method, a reverse roll coating method, a comma coating method, a knife coating method, a spray coating method, a curtain coating method, a dipping method, a spin coating method, and the like can be used, but the applying method is not particularly limited thereto. As the printing method, for example, a relief printing method, an offset printing method, a gravure printing method, an intaglio printing method, a rubber plate printing method, a screen printing method and the like can be used, but the printing method is not particularly limited thereto.

In order to make it easy to peel a green sheet from the surface of the support substrate in a later step, it is preferable to perform the peeling processing on the surface of the support substrate in advance. Examples of the peeling processing include a method of coating or printing a composition for providing peelability, on a surface of a support substrate. Examples of the composition for providing peelability contains a binder as a main component and contains a paint to which wax, fluorine or the like is added, a silicone resin, or the like.

Next, a paste layer is dried to form a green sheet on the surface of the support substrate. Examples of the drying method include natural drying, blast drying with hot air, heat drying with infrared rays or far infrared rays, vacuum drying, and the like. These drying methods may be used alone or in combination of two or more. Subsequently, the green sheet is peeled from the support substrate and cut into a predetermined size and shape. Thereby, the unsintered solid electrolyte layer 23 is obtained as the green sheet.

(Step of Producing Exterior Member)

The unsintered exterior member 14 as the green sheet is obtained in the same manner as the above-mentioned “process for producing a solid electrolyte layer” except that the paste for preparing an exterior member is used.

(Step of Producing Battery)

A battery having the configuration illustrated in FIGS. 1A, 1B and 2 is produced as follows. First, the paste for forming the cathode active material layer is coated on one surface of the solid electrolyte layer 23 so that the uncoated portion is formed along four sides of the surface and dried, thereby forming the cathode active material layer 21B. Next, the paste for forming the exterior member is coated on the uncoated portion and dried to form the exterior member 14 having substantially the same thickness as that of the cathode active material layer 21B. Subsequently, the paste for forming the cathode current collecting layer is coated on the surface formed by the cathode active material layer 21B and the exterior member 14 so that the uncoated portion is formed along three sides of the surface and dried, thereby forming the cathode current collecting layer 21A.

Next, the paste for forming the anode layer is coated on another surface of the solid electrolyte layer 23 so that the uncoated portion is formed along three sides of the surface and dried, thereby forming the anode layer 22. Subsequently, the paste for forming the exterior member is coated on the uncoated portion and dried to form the exterior member 14 having substantially the same thickness as that of the anode layer 22. As a result, the unsintered battery element 20 whose end face is covered with the unsintered exterior member 14 is obtained.

Next, the exterior member as the green sheet is disposed on both main surfaces of the battery element 20 to cover both main surfaces of the battery element 20, thereby obtaining the unsintered exterior battery element 11. Subsequently, the exterior battery element 11 is heated at a temperature equal to or higher than an oxidation combustion temperature of a resin binder contained in each layer of the unsintered exterior battery element 11 to burn (degrease) the resin binder. Thereafter, the exterior battery element 11 is heated at a temperature equal to or higher than a softening point of the solid electrolyte contained in each layer of the battery to sinter the solid electrolyte.

Next, the conductive paste is dipped in the first and second end faces 11SA and 11SB of the exterior battery element 11. Thereafter, the exterior battery element 11 is fired at the curing temperature of the conductive paste. As a result, the targeted battery can be obtained.

[Effect]

In a battery provided with an anode layer having a two-layer structure which is formed of an anode current collecting layer containing a metal material and an anode active material layer containing a carbon material, the surface of the anode current collecting layer and the surface of the metal material are oxidized during the sintering of the anode layer to form a metal oxide film. During charging, lithium ions are inserted into the carbon material contained in the anode active material layer. Since the potential of the carbon material into which lithium ions are inserted is low, the metal oxide film formed on the surface of the anode current collecting layer and the surface of the metal material is reduced and an irreversible capacity occurs. The irreversible capacity is considered to occur due to passivation of Li ions by causing the Li ions to deprive the metal oxide of oxygen, reducing the metal, and oxidizing Li (or a compound thereof). On the other hand, the battery according to the first embodiment is provided with the anode layer 22 having a single-layer structure containing the carbon material having the functions of both the anode current collecting layer and the anode active material layer, instead of the above-described anode layer having a two-layer structure. Therefore, since the anode layer 22 does not contain the metal material which is likely to be oxidized during sintering, or the content of the metal material contained in the anode layer 22 is small, the irreversible capacity can be inhibited from increasing due to the reduction reaction of the metal oxide film.

In addition, since the volume occupancy of the carbon material in the anode layer 22 is 50 vol % to 95 vol %, the reduction in energy density and electrical conductivity of the anode layer 22 can be suppressed, and the reduction in strength of the anode layer 22 can be suppressed.

Since the battery according to the first embodiment is provided with the anode layer 22 having the functions of both the anode current collecting layer and the anode active material layer, instead of the above-described anode layer having a two-layer structure, it is possible to reduce the number of times of film formation during the production of the battery. Therefore, the productivity of the battery can be improved.

### MODIFIED EXAMPLE

### Modified Example 1

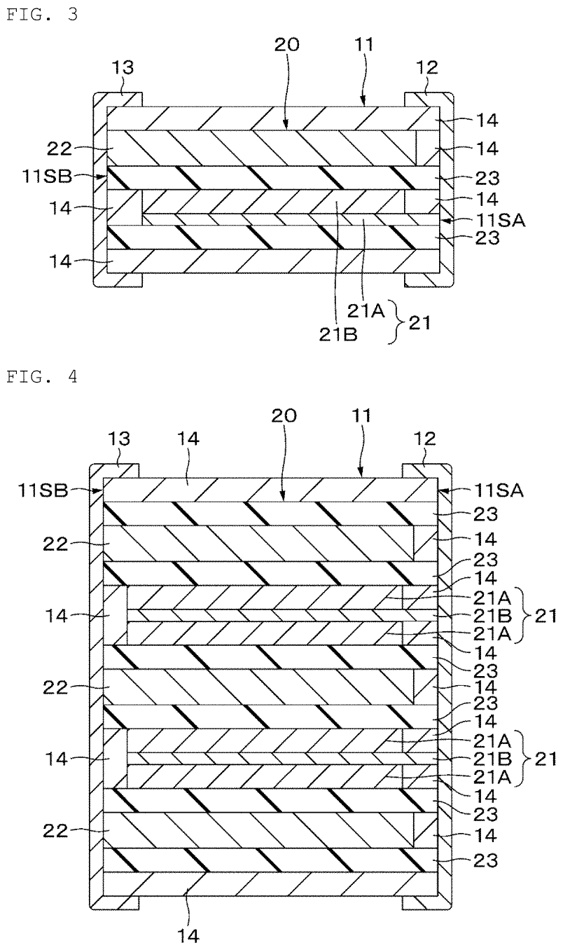

In the first embodiment, the case where the cathode layer 21 is formed on the exterior member 14 has been described, but as illustrated in FIG. 3, the solid electrolyte layer 23 may be provided between the cathode layer 21 and the exterior member 14.

### Modified Example 2

In the first embodiment, the configuration in which the battery element 20 includes one cathode layer 21, one anode layer 22, and one solid electrolyte layer 23 has been described, but the number of cathode layers 21, anode layers 22, and solid electrolyte layers 23 are not particularly limited as long as the configuration of the battery element 20 is such that the cathode layer 21 and the anode layer 22 are stacked with the solid electrolyte layer 23 interposed therebetween.

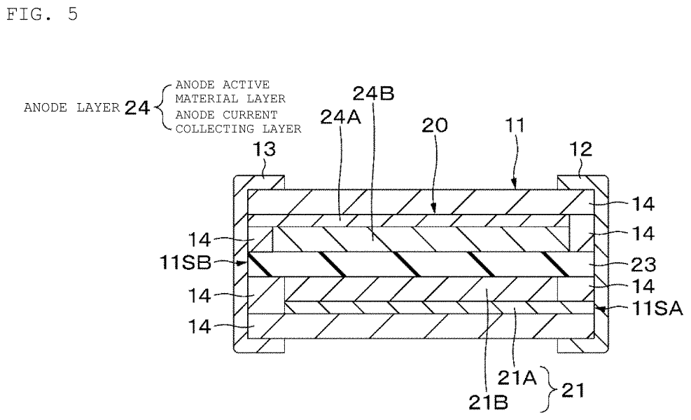

FIG. 4 illustrates an example of a configuration in which the battery element 20 includes two cathode layers 21, three anode layers 22, and six solid electrolyte layers 23. The cathode layers 21 and the anode layers 22 are alternately stacked with the solid electrolyte layers 23 interposed therebetween. The solid electrolyte layers 23 are provided on both main surfaces of the battery element 20. The two cathode layers 21 include the cathode current collecting layer 21A and the cathode active material layer 21B provided on both main surfaces of the cathode current collecting layer 21A.

One end of the two cathode current collecting layers 21A is exposed from the first end face 11SA. The cathode terminal 12 is electrically connected to one end of the exposed two cathode current collecting layers 21A. On the other hand, one end of the three anode layers 22 is exposed from the second end face 11SB. The anode terminal 13 is electrically connected to one end of the exposed three anode layers 22.

### Modified Example 3

In the first embodiment, the case where the main surface of the exterior battery element 11 has a quadrangular shape is described, but the shape of the main surface of the exterior battery element 11 is not particularly limited thereto. For example, the main surface of the exterior battery element 11 may have a circular shape, an oval shape, a polygonal shape other than a quadrangular square, or an irregular shape. In addition, the shape of the exterior battery element 11 is not limited to a plate shape, but may be a sheet shape, a block shape or the like. In addition, the exterior battery element 11 may be curved or bent.

### Modified Example 4

In the first embodiment described above, the example in which the present technology is applied to the battery using lithium as the electrode reactant is described, but the present technology is not limited to this example. The present technology may be applied to a battery using, for example, another alkali metal such as Na or K, alkali earth metal such as Mg or Ca, or another metal such as Al or Ag as the electrode reactant.

### Modified Example 5

In the first embodiment described above, the case where all the layers of the cathode current collecting layer 21A, the cathode active material layer 21B, and the anode layer 22 include the solid electrolyte are described, but at least one of the cathode current collecting layer 21A, the cathode active material layer 21B, and the anode layer 22 may not include the solid electrolyte. In this case, a layer not containing the solid electrolyte may be, for example, a thin film produced by a vapor growth method such as a vapor deposition method or a sputtering method.

### Modified Example 6

The solid electrolyte contained in the cathode current collecting layer 21A, the cathode active material layer 21B, the anode layer 22, and the solid electrolyte layer 23 is not particularly limited. As solid electrolytes other than the solid electrolyte of the first embodiment, for example, a perovskite type oxide crystal formed of La—Li—Ti—O and the like, a garnet type oxide crystal formed of Li—La—Zr—O and the like, a phosphate compound (LATP) containing lithium, aluminum, and titanium as a constituent element, a phosphate compound (LAGP) containing lithium, aluminum, and germanium as a constituent element, and the like can be used.

In addition, sulfide such as Li₂S—P₂S₅, Li₂S—SiS₂—Li₃PO₄, Li₇P₃S₁₁, Li_{3.25}Ge_{0.25}P_{0.75}S, or Li₁₀GeP₂S₁₂ or oxide such as Li₇La₃Zr₂O₁₂, Li_{6.75}La₃Zr_{1.75}Nb_{0.25}O₁₂, Li₆BaLa₂Ta₂O₁₂, Li₁₊ₓAlₓTi₂₋ₓ(PO₄)₃, or La_{2/3-x}Li₃ₓTiO₃ can also be used.

### Other Modified Examples

The structure of the battery element 20 is not particularly limited, and may have a bipolar type laminated structure. In addition, at least one of the cathode current collecting layer 21A, the cathode active material layer 21B, and the anode layer 22 may be a sintered body of a green sheet. In addition, at least one of the cathode current collecting layer 21A, the cathode active material layer 21B, the anode layer 22, and the solid electrolyte layer 23 may be a green compact. The anode layer 22 may contain a carbon material, metal grain powder such as Ni grain powder, and a solid electrolyte.

### 2 Second Embodiment

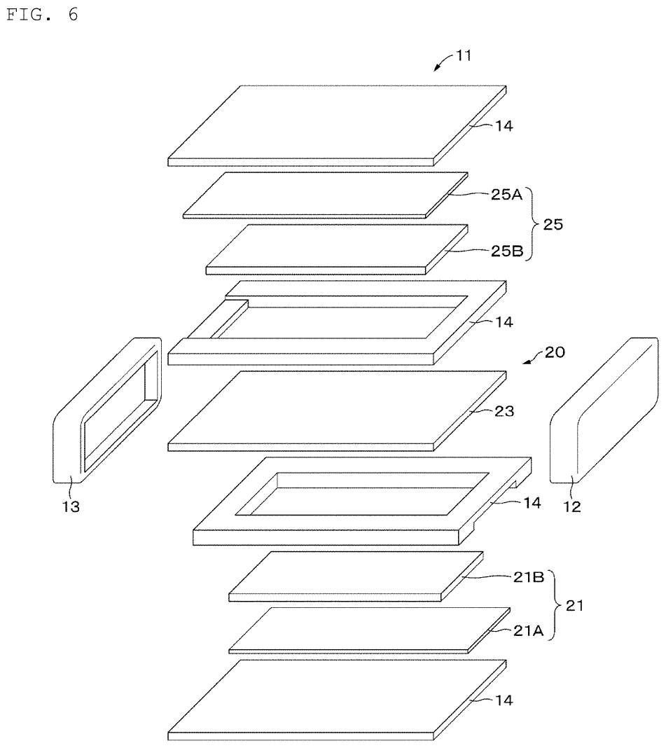

A battery according to a second embodiment of the present technology differs from the battery according to a first embodiment in that an anode layer 24 having a two-layer structure is provided instead of an anode layer 22 having a single-layer structure, as illustrated in FIGS. 5 and 6. In the second embodiment, the same parts as those of the first embodiment are denoted by the same reference numerals, and the description thereof will be omitted.

The anode layer 24 includes an anode current collecting layer 24A and an anode active material layer 24B which is provided on a main surface of a side facing the cathode layer 21, among both main surfaces of the anode current collecting layer 24A.

(Anode Current Collecting Layer)

The anode current collecting layer 24A contains a carbon material and a solid electrolyte. As the carbon material, those similar to the carbon material contained in the cathode current collecting layer 21A of the first embodiment can be exemplified. The carbon material preferably contains at least one of graphite, acetylene black, ketjen black and carbon fiber from the viewpoint of obtaining high electrical conductivity.

A volume occupancy of the carbon material in the anode current collecting layer 24A is preferably 50 vol % to 95 vol %. If the volume occupancy is less than 50 vol %, there is a possibility that the electrical conductivity of the anode current collecting layer 24A is reduced. On the other hand, if the volume occupancy exceeds 95 vol %, the volume occupancy of the solid electrolyte in the anode current collecting layer 24A is too small, such that there is a possibility that the strength of the anode current collecting layer 24A is reduced. The volume occupancy of the carbon material in the anode current collecting layer 24A can be obtained in the same manner as “the method of calculating a volume occupancy of a carbon material in an anode layer 22” of the first embodiment, from a three-dimensional SEM image.

As the solid electrolyte, the solid electrolyte contained in the solid electrolyte layer 23 of the first embodiment can be exemplified. However, a composition (type of material) or a composition ratio of the solid electrolyte contained in the solid electrolyte layer 23 and the anode current collecting layer 24A may be the same or different.

(Anode Active Material Layer)

An anode active material layer 24B contains an anode active material and a solid electrolyte. The solid electrolyte may have a function as a binder. The anode active material layer 24B may further contain a conductive agent as needed.

The anode active material contains a carbon material capable of occluding and releasing lithium ions which is an electrode reactant. Since the potential of the carbon material into which lithium ions are inserted is low, there is a possibility that irreversible capacity is particularly large due to a reduction reaction unless the anode current collecting layer 24A containing the carbon material is used instead of using the anode current collecting layer containing the metal material. As the carbon material, those similar to the carbon material contained in the anode layer 22 of the first embodiment can be exemplified. However, the anode active material may contain a metal-based material and the like in addition to the carbon material. As the metal-based material which is the anode active material, those similar to the metal-based material contained in the anode layer 22 of the first embodiment can be exemplified.

The volume occupancy of the carbon material in the anode active material layer 24B is 50 vol % to 95 vol %. If the volume occupancy is less than 50 vol %, there is a possibility that the energy density and the electrical conductivity of the anode active material layer 24B are reduced. On the other hand, if the volume occupancy exceeds 95 vol %, the volume occupancy of the solid electrolyte in the anode active material layer 24B is too small, such that there is a possibility that the strength of the anode active material layer 24B is reduced. The volume occupancy of the carbon material in the anode active material layer 24B can be obtained from the three-dimensional SEM image in the same manner as “the method of calculating a volume occupancy of a carbon material in an anode layer 22” of the first embodiment. The types of carbon materials contained in the anode current collecting layer 24A and the anode active material layer 24B may be the same or different.

As the solid electrolyte, the solid electrolyte contained in the solid electrolyte layer 23 of the first embodiment can be exemplified. However, a composition (type of material) or a composition ratio of the solid electrolyte contained in the solid electrolyte layer 23 and the anode layer 22 may be the same or different.

Examples of the conductive agent contain at least one of the carbon material and the metal material. As the carbon material and the metal material, those similar to the carbon material and the metal material which are contained in the above-mentioned cathode active material layer 21B can be exemplified.

### Effect

The battery according to the second embodiment is provided with the anode current collecting layer 24A containing the carbon material, instead of the anode current collecting layer containing the metal material. For this reason, it is possible to inhibit the irreversible capacity from increasing due to the reduction reaction.

In addition, since the carbon material is softer than the metal material, a favorable interface can be formed between the anode current collecting layer 24A and the anode active material layer 24B. Therefore, the interface resistance between the anode current collecting layer 24A and the anode active material layer 24B can be reduced. In addition, since the carbon material is less expensive than the metal material, the production cost of the battery can be reduced.

When the cathode current collecting layer 21A contains a carbon material, the interface resistance between the cathode current collecting layer 21A and the cathode active material layer 21B can be reduced.

### Modified Example

The anode current collecting layer 24A may further contain a metal material in addition to the carbon material. As the metal material, for example, metal grain powder, such as Ni grain powder, can be used. The battery includes the anode current collecting layer 24A containing the carbon material and the metal material instead of the anode current collecting layer containing metal grains, such that the content of the metal material contained in the anode current collecting layer 24A can be reduced. Therefore, it is possible to inhibit the irreversible capacity from increasing due to the reduction reaction. When the anode current collecting layer 24A further contains the metal material, from the viewpoint of suppressing the occurrence of the irreversible capacity, the volume ratio of the metal material to the carbon material (metal material/carbon material) is preferably 0.5 or less, more preferably 0.3 or less, still more preferably 0.1 or less, and particularly preferably 0.05 or less.

### 3 Example

Hereinafter, the present technology will be specifically described with reference to Examples, but is not limited to only these Examples.

Examples will be described in the following order.

i Sample in which volume occupancy of carbon material or Ni in current collecting layer is changed, and sample in which volume occupancy of carbon material in anode layer is changed

ii Sample in which anode current collecting layer containing Ni grains is provided between anode active material layer and Ni foil, and sample in which anode current collecting layer containing Ni grains is not provided between anode active material layer and Ni foil

iii Sample in which cathode current collecting layer containing Ni grains as cathode current collecting layer is provided

iv Sample in which cathode current collecting layer containing carbon material as cathode current collecting layer is provided, and sample in which anode current collecting layer containing Ni grains as cathode current collecting layer is provided

<i Sample in which Volume Occupancy of Carbon Material or Ni in Current Collecting Layer is Changed, and Sample in which Volume Occupancy of Carbon Material in Anode Layer is Changed>

[Samples 1-1 to 1-4]

(Step of Preparing Paste for Forming Current Collecting Layer)

First, oxide glass (hereinafter, referred to as “oxide glass A”) containing Li₂O, SiO₂, and B₂O₃ in a molar ratio of Li₂O:SiO₂:B₂O₃=60:10:30 was prepared. Next, after vapor grown carbon fiber (manufactured by Showa Denko KK, VGCF-H) as a conductive material and oxide glass A as a low temperature sintered glass are blended at a volume ratio of as 50:50 and 80:20 (vapor grown carbon fiber:oxide glass A) as shown in Table 1, the resulting blends and a resin binder were dispersed in a high boiling point solvent to prepare a paste for forming a current collecting layer.

(Step of Producing Current Collecting Layer)

First, the paste for forming the current collecting layer produced was coated onto a release film and dried to form a current collecting layer having a thickness of 5 and 10 μm as shown in Table 1. Next, the current collecting layer was punched into a rectangular shape together with the release film, and then the current collecting layer was peeled from the release film. Thereby, the rectangular current collecting layer as a green sheet was obtained. Subsequently, the obtained current collecting layer was heated at a temperature equal to or higher than an oxidation combustion temperature of a resin binder contained in the current collecting layer to burn (degrease) the resin binder. Thereafter, the current collecting layer was heated at a temperature equal to or higher than a softening point of oxide glass A contained in the current collecting layer to sinter the oxide glass A. As a result, the targeted current collecting layer can be obtained.

(Samples 1-5 to 1-8)

First, oxide glass (hereinafter, referred to as “oxide glass B”) containing Li₂O, SiO₂, and B₂O₃ in a molar ratio of Li₂O:SiO₂:B₂O₃=54:11:35 was prepared. Next, after artificial graphite (manufactured by TIMCAL Co., KS6) as a conductive material and oxide glass B as a low temperature sintered glass were blended at a volume ratio of as 35:65, 50:50, and 80:20 (artificial graphite:oxide glass B) as shown in Table 1, the resulting blends and a resin binder were dispersed in a high boiling point solvent to prepare a paste for forming a current collecting layer. The subsequent steps were performed in the same manner as the samples 1-1 and 1-2 to obtain the current collecting layer.

(Samples 1-9 and 1-10)

A current collecting layer was obtained in the same manner as in the samples 1-3 and 1-4 except that the artificial graphite (manufactured by TIMCAL Co., KS6) was used as the conductive material.

(Sample 1-11)

Artificial graphite (manufactured by TIMCAL Co., KS6) as a conductive material and Bi—B-based glass as a low temperature sintered glass were blended at a volume ratio of 70:30 show in Table 1. In addition, as shown in Table 1, a thickness of the unsintered current collecting layer as a green sheet was set to 30 μm. Except for this, the current collecting layer was obtained in the same manner as in the sample 1-1.

(Samples 1-12 and 1-13)

A current collecting layer was obtained in the same manner as in the samples 1-7 and 1-8 except that the artificial graphite (manufactured by TIMCAL Co., KS15) was used as the conductive material.

(Samples 1-14 and 1-15)

A current collecting layer was obtained in the same manner as in the samples 1-7 and 1-8 except that the ketjen graphite (KB) was used as the conductive material.

(Samples 1-16 and 1-17)

As shown in Table 1, a current collecting layer was obtained in the same manner as the samples 1-1 and 1-2 except that Ni grain powder (average grain diameter of 1 μm) as a conductive material and oxide glass B as a low temperature sintered glass are blended at a volume ratio of 95:5 (=Ni grain powder:oxide glass B) as shown in Table 1.

(Samples 2-1 to 2-4)

First, natural graphite (manufactured by BTR NEW ENERGY MATERIALS Inc, AGP8) and artificial graphite (manufactured by TIMCAL, KS6) were mixed to prepare an anode material. Next, after the prepared anode material and the oxide glass B as a low temperature sintered are blended at a volume ratio of 50:50 and 80:20 (=anode material:oxide glass B) as shown in Table 2, the resulting blends and a resin binder were dispersed in a high boiling point solvent to prepare a paste for forming the anode layer. In the subsequent steps, the anode layer was obtained in the same manner as the samples 1-1 and 1-2.

(Volume Resistivity)

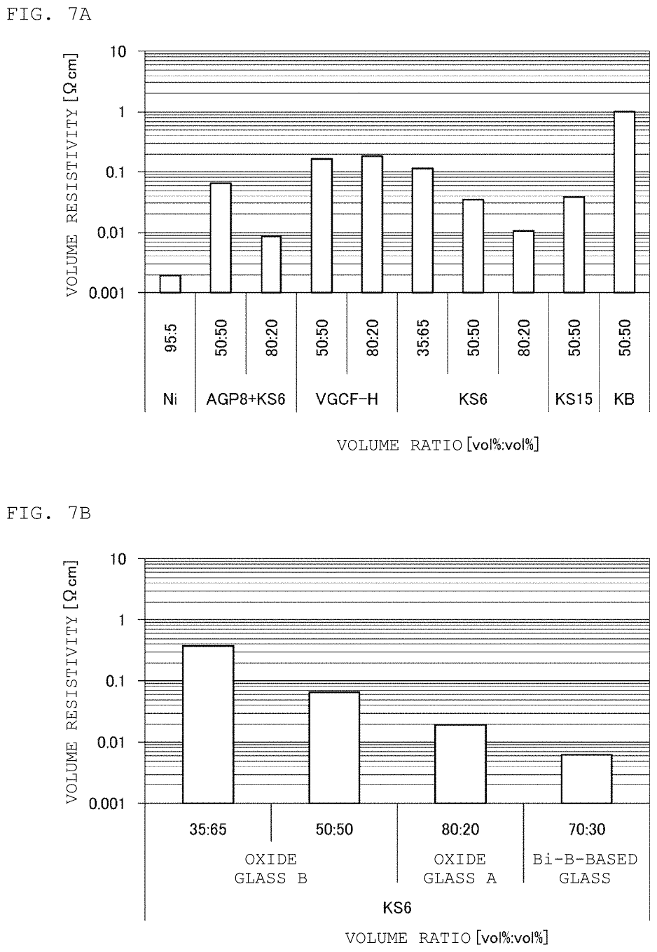

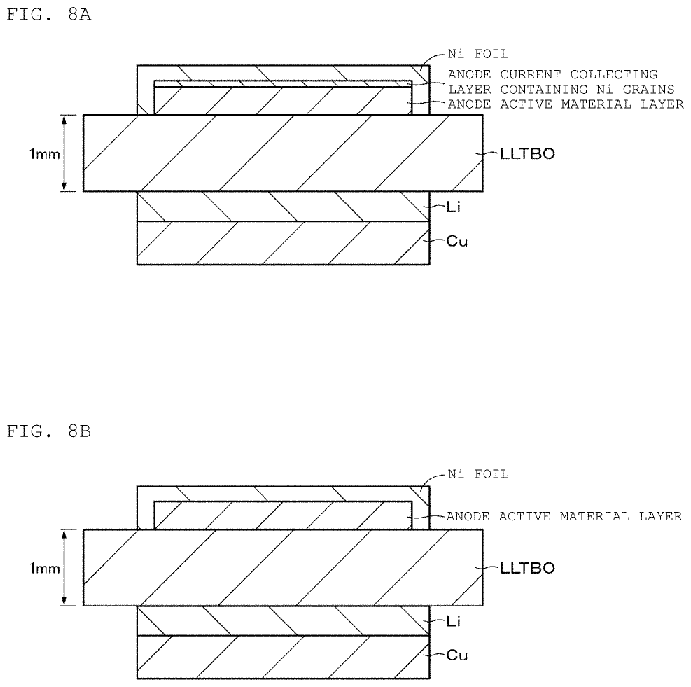

A volume resistivity of a current collecting layer and an anode layer was measured by a four-terminal method according to JIS K 7194-1994. As a measuring device, Lorester manufactured by Mitsubishi Chemical was used. The results are shown in Tables 1 and 2 and FIGS. 7A and 7B. FIG. 7A illustrates measurement results of the volume resistivity of the samples 1-2, 1-4, 1-6, 1-8, 1-10, 1-13, 1-15, 1-17, 2-2, and 2-4. FIG. 7B illustrates the measurement results of the volume resistivity of the samples 1-5, 1-7, 1-9, and 1-11.

Table 1 shows the configurations of the current collecting layers of the samples 1-1 to 1-17 and the measurement results of the volume resistivity.

TABLE 1

| | | | | Composition | | |
|---|---|---|---|---|---|---|
| | | | | ratio | | |
| | | | | (volume ratio) | | |
| | | | | [conductive | Film | Volume |
| | Member | Conductive | Glass | material:glass | thickness | resistivity |
| | type | material | material | material] | (μm) | (Ωcm) |
| Sample 1-1 | Current | VGCF-H | Oxide glass A | 50:50 | 5 | 2.473E−01 |
| | collecting | | | | | |
| | layer | | | | | |
| Sample 1-2 | Current | VGCF-H | Oxide glass A | 50:50 | 10 | 1.633E−01 |
| | collecting | | | | | |
| | layer | | | | | |
| Sample 1-3 | Current | VGCF-H | Oxide glass A | 80:20 | 5 | 2.032E−01 |
| | collecting | | | | | |
| | layer | | | | | |
| Sample 1-4 | Current | VGCF-H | Oxide glass A | 80:20 | 10 | 1.796E−01 |
| | collecting | | | | | |
| | layer | | | | | |
| Sample 1-5 | Current | KS6 | Oxide glass B | 35:65 | 5 | 3.699E−01 |
| | collecting | | | | | |
| | layer | | | | | |
| Sample 1-6 | Current | KS6 | Oxide glass B | 35:65 | 10 | 1.176E−01 |
| | collecting | | | | | |
| | layer | | | | | |
| Sample 1-7 | Current | KS6 | Oxide glass B | 50:50 | 5 | 6.456E−02 |
| | collecting | | | | | |
| | layer | | | | | |
| Sample 1-8 | Current | KS6 | Oxide glass B | 50:50 | 10 | 3.490E−02 |
| | collecting | | | | | |
| | layer | | | | | |
| Sample 1-9 | Current | KS6 | Oxide glass A | 80:20 | 5 | 1.910E−02 |
| | collecting | | | | | |
| | 1ayer | | | | | |
| Sample 1-10 | Current | KS6 | Oxide glass A | 80:20 | 10 | 1.091E−02 |
| | collecting | | | | | |
| | layer | | | | | |
| Sample 1-11 | Current | KS6 | Bi-B-based | 70:30 | 30 | 6.190E−03 |
| | collecting | | glass | | | |
| | layer | | | | | |
| Sample 1-12 | Current | KS15 | Oxide glass B | 50:50 | 5 | 1.313E−01 |
| | collecting | | | | | |
| | layer | | | | | |
| Sample 1-13 | Current | KS15 | Oxide glass B | 50:50 | 10 | 3.946E−02 |
| | collecting | | | | | |
| | layer | | | | | |
| Sample 1-14 | Current | KB | Oxide glass B | 50:50 | 5 | 1.774E+00 |
| | collecting | | | | | |
| | layer | | | | | |
| Sample 1-15 | Current | KB | Oxide glass B | 50:50 | 10 | 1.019E+00 |
| | collecting | | | | | |
| | layer | | | | | |
| Sample 1-16 | Current | Ni(1 μm) | Oxide glass B | 95:5 | 5 | 6.649E+03 |
| | collecting | | | | | |
| | layer | | | | | |
| Sample 1-17 | Current | Ni(1 μm) | Oxide glass B | 95:5 | 10 | 1.957E−03 |
| | collecting | | | | | |
| | layer | | | | | |

Table 2 shows the configurations of the anode layers of the samples 2-1 to 2-4 and the measurement results of the volume resistivity.

TABLE 2

| | | | | Composition | | |
|---|---|---|---|---|---|---|
| | | | | ratio | | |
| | | | | (volume ratio) | | |
| | | | | [anode | Film | Volume |
| | Member | Anode | Glass | material:glass | thickness | resistivity |
| | type | material | material | material] | (μm) | (Ωcm) |
| Sample 2-1 | Anode | AGP8 + KS6 | Oxide glass B | 50:50 | 5 | 8.959E−02 |
| | layer | | | | | |
| Sample 2-2 | Anode | AGP8 + KS6 | Oxide glass B | 50:50 | 10 | 6.568E−02 |
| | layer | | | | | |
| Sample 2-3 | Anode | AGP8 + KS6 | Oxide glass B | 80:20 | 5 | 1.117E−02 |
| | layer | | | | | |
| Sample 2-4 | Anode | AGP8 + KS6 | Oxide glass B | 80:20 | 10 | 8.848E−03 |
| | layer | | | | | |

Note that the oxide glass A and the oxide glass B in the description column of “glass material” in Table 1 and Table 2 mean the oxide glass which has the following compositions.

Oxide glass A: Oxide glass containing Li₂O, SiO₂, and B₂O₃ in a molar ratio of Li₂O, SiO₂, and B₂O₃=60:10:30

Oxide glass B: Oxide glass containing Li₂O, SiO₂, and B₂O₃ in a molar ratio of Li₂O, SiO₂, and B₂O₃=54:11:35

In addition, in the column of “volume resistivity” in Tables 1 and 2, the notations “AE+B” and “AE−B” mean A×10_{+B} and A×10_{-B}, respectively.

The following can be seen from Table 1 and Table 2.

The good volume resistivity can be obtained by setting the volume occupancy of the carbon material in the current collecting layer to be 50 vol % or more. Therefore, a good current collecting layer can be obtained.

The good volume resistivity can be obtained by setting the volume occupancy of the carbon material in the anode layer to be 50 vol % or more. Therefore, it is possible to obtain a single-layer anode layer having the functions of two layers of the anode current collecting layer and the anode active material layer.

<ii Sample in which Anode Current Collecting Layer Containing Ni Grains is Provided Between Anode Active Material Layer and Ni Foil, and Sample in which Anode Current Collecting Layer Containing Ni Grains is not Provided Between Anode Active Material Layer and Ni Foil>

[Sample 3-1]

(Step of Preparing Paste for Forming Solid Electrolyte Layer)

First, the oxide glass (LiLaTaBaO) was prepared as the solid electrolyte. Next, the oxide glass and the resin binder were dispersed in the high boiling point solvent to prepare the paste for forming the solid electrolyte layer.

(Step of Producing Solid Electrolyte Layer)

The solid electrolyte layer was produced as follows. First, the paste for forming the solid electrolyte layer was coated on the release film and dried to form the solid electrolyte layer on the release film. Next, the current collecting layer was punched into a rectangular shape together with the release film, and then the solid electrolyte layer was peeled from the release film. Thereby, the rectangular solid electrolyte layer as the green sheet was obtained.

(Step of Preparing Paste for Forming Anode Current Collecting Layer)

Ni grain powder (average grain diameter of 1 μm) as a conductive material and oxide glass B as a low temperature sintered glass were blended at a volume ratio of 68:32 (=(Ni grain powder:oxide glass B)) and the resulting blends and a resin binder were dispersed in the high boiling point solvent to prepare a paste for forming an anode current collecting layer containing Ni grains.

(Step of Preparing Paste for Forming Anode Active Material Layer)

Graphite (artificial graphite (manufactured by TIMCAL Co., KS6)+natural graphite (manufactured by BTR NEW ENERGY MATERIALS Inc, AGP8)) as an anode active material and oxide glass B as a low temperature sintered glass were blended at a volume ratio of 1:1 (=graphite:oxide glass B) and the resulting blends and a resin binder were dispersed in a high boiling point solvent to prepare a paste for forming an anode active material layer.

(Step of Forming Anode Layer)

First, the paste for forming the anode current collecting layer was coated on one surface of the Ni foil and dried to form the anode current collecting layer containing Ni grains. Next, the paste for forming the anode active material layer was coated on the anode current collecting layer and dried to form the anode electrode active material layer. Thereby, the anode was obtained

(Step of Producing Battery)

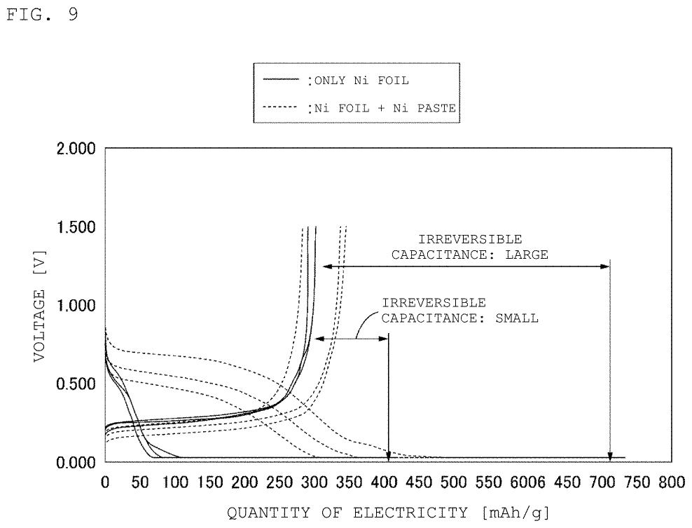

A battery having a configuration illustrated in FIG. 8A was produced as follows. First, a Li metal foil was prepared as a counter electrode, and a copper layer was formed on one surface of this Li metal foil. Next, the solid electrolyte layer was placed on the Li metal foil, and then the anode layer was placed on the solid electrolyte layer so that the anode active material layer and the solid electrolyte face each other, thereby obtaining the unsintered battery. Subsequently, the battery was heated at a temperature equal to or higher than the oxidation combustion temperature of the resin binder contained in the solid electrolyte layer, the anode current collecting layer, and the anode active material layer of the unsintered battery to burn (degrease) the resin binder. Thereafter, the low temperature sintered glass was sintered by heating the battery at a temperature equal to or higher than the softening point of the low temperature sintered glass contained in the solid electrolyte layer, the anode current collecting layer, and the anode active material layer of the battery. From the above, the targeted battery (half cell) was obtained.

[Sample 3-2]

As illustrated in FIG. 8B, the battery was obtained in the same manner as in the sample 3-1, except that the anode current collecting layer containing Ni grains was not formed between the anode active material layer and the Ni foil.

(Charge and Discharge Curve)

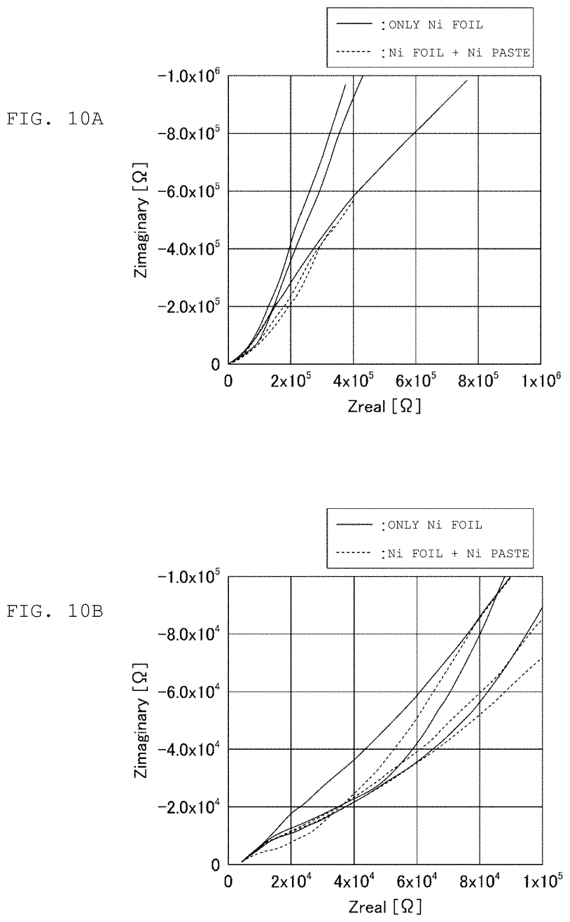

The charge and discharge test of the battery was performed under the following conditions to obtain a charge and discharge curve. The results are illustrated in FIG. 9.

Measurement environment conditions: Dry air atmosphere, 23° C.

Charge and discharge condition: 1 μA CC (Constant Current) only (no CV mode), 0.03 Vcut

Discharge condition: 1 μA CC (Constant Current), 2.0 Vcut

(Impedance Curve)

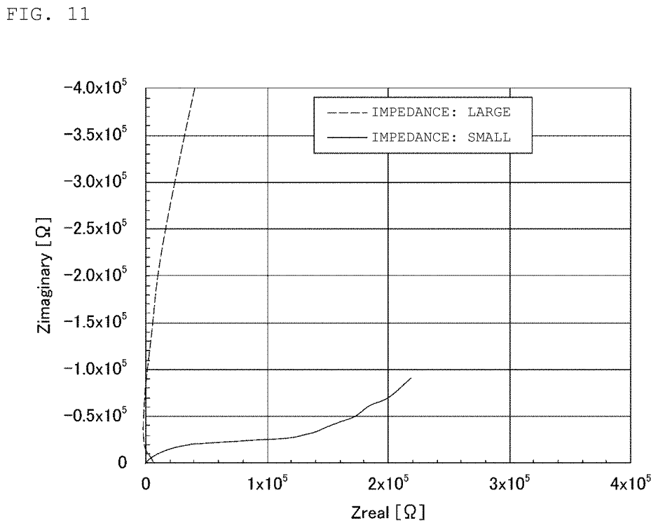

Three batteries of the samples 3-1 and 3-2 were each prepared, and AC impedance measurement was performed on a battery at room temperature (23° C.) using an impedance measuring device (manufactured by Toyo Technica Co. Ltd.) to obtain the impedance curve. The results are illustrated in FIGS. 10A and 10B.

It can be seen from FIGS. 10A and 10B that an arc of the impedance curve small can be reduced by providing the anode current collecting layer containing Ni grains between the anode active material layer and the Ni foil, that is, the adhesion between the anode active material layer and the Ni foil can be improved, and the interface resistance can be reduced.

However, it can be seen from FIG. 9 that a large irreversible capacity occurs when the anode current collecting layer containing the Ni grains is provided between the anode active material layer and the Ni foil. It is considered that this is because the metal oxide film was formed on the surface of the metal grains in the sintering step and this metal oxide film was reduced during charging. In the battery of the sample 3-1 (half cell), Li metal is used as an Li source, charging and discharging can be performed without depleting Li on the opposite side, but when LCO (LiCoO₂) is used instead of the Li source, the irreversible capacity increases and the discharge becomes difficult.

Even in the battery (half cell) of the sample 3-2 in which the anode current collecting layer containing the Ni grains is not provided between the anode active material layer and the Ni foil, the metal oxide film formed on the surface of the Ni foil is reduced. However, since the Ni grain powder has a larger specific surface area than that of the Ni foil, the occurrence of the reduction of the metal oxide film becomes more remarkable on the battery (half cell) of the sample 3-1 in which the anode current collecting layer containing the Ni grains is provided between the anode active material layer and the Ni foil, such that the battery of the sample 3-1 has a larger irreversible capacity than that of the battery of the sample 3-2.

<iii Sample in which Cathode Current Collecting Layer Containing Ni Grains as Cathode Current Collecting layer is Provided>

[Sample 4-1]

A plurality of batteries having the same configuration were produced as follows.

(Step of Preparing Paste for Forming Cathode Current Collecting Layer)

The Ni grain powder (average grain diameter of 1 μm) as the conductive material and the oxide glass B as the low temperature sintered glass were blended at a volume ratio of 68:32 (=Ni grain powder:oxide glass B), and the resulting blends and the resin binder were dispersed in the high boiling point solvent to prepare the paste for forming the cathode current collecting layer.

(Step of Preparing Paste for Forming Cathode Active Material Layer)

The lithium cobalt oxide (LiCoO₂) as the cathode active material and the oxide glass B as the low temperature sintered glass were blended at a volume ratio of 1:2 (=LiCoO₂:oxide glass B), and the resulting blends and the resin binder were dispersed in the high boiling point solvent to prepare the paste for forming the cathode active material layer.

(Step of Preparing Paste for Forming Anode Layer)

Graphite (artificial graphite (manufactured by TIMCAL Co., KS6)+natural graphite (manufactured by BTR NEW ENERGY MATERIALS Inc, AGP8)) as the anode active material and oxide glass B as the low temperature sintered glass were blended at a volume ratio of 1:1 (=graphite:oxide glass B) and the resulting blends and a resin binder were dispersed in a high boiling point solvent to prepare a paste for forming an anode layer.

(Step of Preparing Paste for Forming Solid Electrolyte Layer)

The oxide glass A as the low temperature sintered glass and the resin binder were dispersed in the high boiling point solvent to prepare the paste for forming the solid electrolyte layer.

(Step of Preparing Paste for Forming Exterior Member)

The paste for forming the exterior member was prepared by blending alumina grains (manufactured by Nippon Light Metal, AHP 300) as crystal grains and the oxide glass A as the low temperature sintered glass and dispersing the resulting blends and a resin binder in a high boiling point solvent.

(Step of Producing Solid Electrolyte Layer)

The two solid electrolyte layers were produced as follows. First, the paste for forming the solid electrolyte layer was coated on the release film and dried to form the solid electrolyte layer on the release film. Next, the current collecting layer was punched into a rectangular shape together with the release film, and then the solid electrolyte layer was peeled from the release film. Thereby, the rectangular solid electrolyte layer as the green sheet was obtained.

(Step of Producing Exterior Member)

The two exterior members were prepared as follows. First, the paste for forming the exterior member was coated on the release film and dried to form the exterior member on the release film. Next, the solid electrolyte layer was punched into a rectangular shape together with the release film, and then the exterior member was peeled from the release film. Thereby, the rectangular exterior member as the green sheet was obtained.

(Step of Producing Battery)

The battery having the configuration illustrated in FIG. 3 was produced as follows.

A first laminate was produced as follows. First, the paste for forming the cathode active material layer is coated on one surface of the solid electrolyte layer so that the uncoated portion is formed along three sides of the surface and dried, thereby forming the cathode current collecting layer. Next, the paste for forming the exterior member is coated on the uncoated portion and dried to form the exterior member having substantially the same thickness as that of the cathode current collecting layer. Subsequently, the paste for forming the cathode active material layer is coated on the surface formed by the cathode current collecting layer and the exterior member so that the uncoated portion is formed along four sides of the surface and dried, thereby forming the cathode active material layer. Thus, the first laminate in which one end of the cathode current collecting layer was exposed from the exterior member was produced.

A second laminate was produced as follows. First, the solid electrolyte layer is prepared separately from the first laminate, and is coated on one surface of the solid electrolyte layer so that the uncoated portion is formed along three sides of the surface and dried to form the anode layer. Next, the paste for forming the exterior member is coated on the uncoated portion and dried to form the exterior member having substantially the same thickness as that of the anode layer. Thus, the second laminate in which one end of the anode layer was exposed from the exterior member was produced.

The exterior battery was produced as follow by using the first laminate, the second laminate, and the exterior member as two green sheets which are obtained as described above. First, the second laminate is stacked on the first laminate so that the cathode active material layer and the anode layer face each other with the solid electrolyte layer interposed therebetween and one end of the cathode current collecting layer exposed from the exterior member and one end of the anode layer exposed from the exterior member are opposite to each other, thereby obtaining the unsintered battery element. Next, the exterior member as the green sheet was disposed on both main surfaces of the battery element to cover both main surfaces of the battery element. Thereby, the unsintered exterior battery was obtained. Subsequently, the exterior battery element is heated at a temperature equal to or higher than an oxidation combustion temperature of the resin binder contained in each layer of the unsintered exterior battery element to burn (degrease) the resin binder. Thereafter, the low temperature sintered glass was sintered by heating the battery at a temperature equal to or higher than the softening point of the low temperature sintered glass contained in each layer of the battery.

Next, after Ag paste is dipped in a first end face of the exterior battery in which one end of the cathode current collecting layer is exposed from the exterior member, Ag paste is dipped in a second end surface of the exterior battery in which one end of the anode layer is exposed from the exterior member. Thereafter, the exterior battery was fired at the curing temperature of the Ag paste.

Thereby, the targeted battery was obtained.

(Impedance Curve)

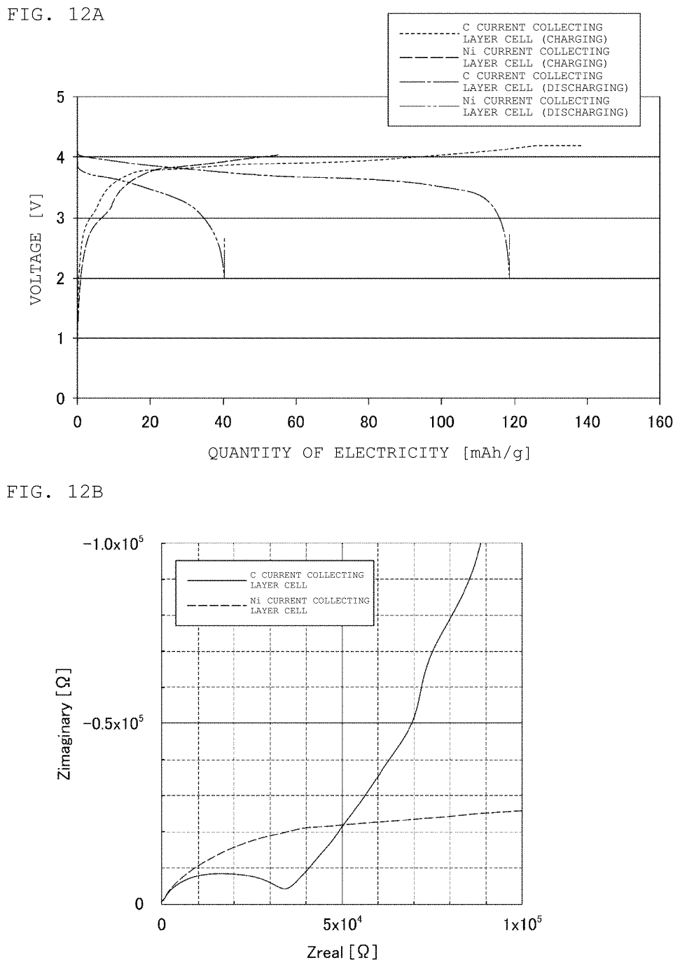

Impedance curves of a plurality of batteries of sample 4-1 were acquired in the same manner as in the case of acquiring the impedance curves of the batteries of the samples 3-1 and 3-2 described above. Among the acquired impedance curves of the plurality of batteries, impedance curves of two batteries with a large difference occurring in characteristics are illustrated in FIG. 11.

It can be seen from FIG. 11 that even if the battery is produced in the same manufacturing step, the battery characteristics may vary and a large difference may occur in the impedance characteristics. It is considered that this is because the Ni grains are not sintered in the cathode current collecting layer, a conductive path is formed by a point contact, and the conductivity of the cathode current collecting layer is unstable.

<iv Sample in which Cathode Current Collecting Layer Containing Carbon Material as Cathode Current Collecting Layer is Provided, and Sample in which Anode Current Collecting Layer Containing Ni Grains as Cathode Current Collecting Layer is Provided>

[Sample 5-1]

Artificial graphite (manufactured by TIMCAL, KS6) as a carbon material and oxide glass A as a low-temperature sintered glass were blended at a volume ratio of 80:20 (=artificial graphite:oxide glass A), and the resulting blends and a resin binder were dispersed in a high boiling point solvent to prepare a paste for forming a cathode current collecting layer. The battery was obtained in the same manner as in the sample 4-1 except that the cathode current collecting layer containing the carbon material was formed using the paste for forming the cathode current collecting layer.

[Sample 5-2]

A battery was obtained in the same manner as in the sample 4-1.

(Charge and Discharge Curve)

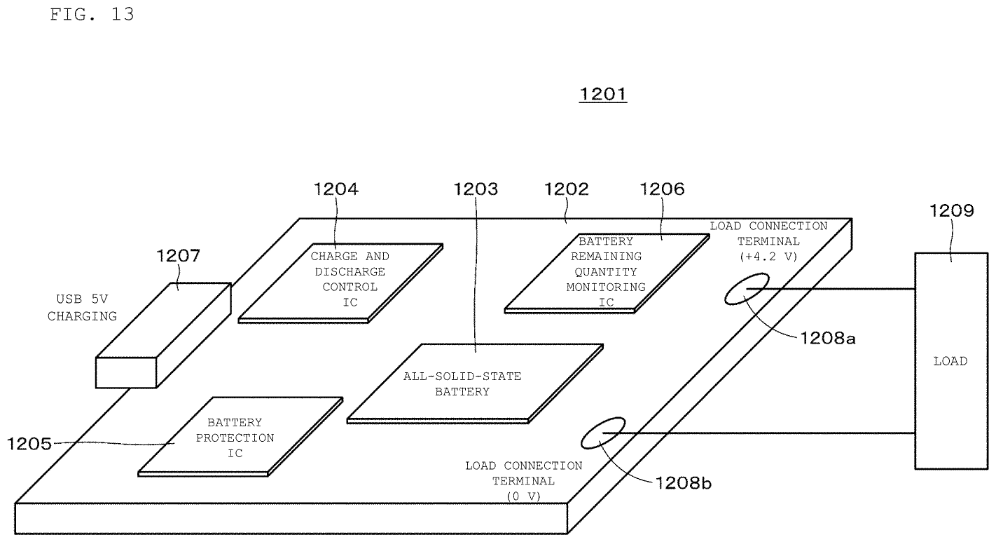

The charge and discharge test of the battery was performed under the following conditions to obtain a charge and discharge curve. The results are illustrated in FIG. 12A.

Measurement environment conditions: Dry air atmosphere, 23° C.

Charge and discharge condition: 2.5 μA CC (Constant Current)→0.3 μACV (Constant Voltage), 4.2 Vcut

Discharge condition: 2.5 μA CC (Constant Current), 2 Vcut

(Impedance Curve)

AC impedance measurement was performed on a battery at room temperature (23° C.) using an impedance measuring device (manufactured by Toyo Technica Co., Ltd.) to obtain an impedance curve.

The results are illustrated in FIG. 12B.

It can be seen from FIG. 12A that the discharge capacity can be improved by using the cathode current collecting layer containing the carbon material instead of the cathode current collecting layer containing the Ni grain powder.

It can be seen from FIG. 12B that the arc of the impedance curve can be reduced by using the cathode current collecting layer containing the carbon material instead of the cathode current collecting layer containing the Ni grain powder, that is, the adhesion between the cathode active material layer and the cathode current collecting layer can be improved, and the interface resistance can be reduced.

The development of the effect is thought to be caused by the formation of the good interface between the cathode current collecting layer and the cathode active material layer, by using a flexible carbon material for the cathode current collecting layer compared to the Ni grain powder.

### 4 Application Example

“Printed Circuit Board as Application Example”

Hereinafter, an application example in which the present disclosure is applied to a printed circuit board will be described.

The above-described battery can be mounted on the printed circuit board together with a charging circuit and the like. For example, electronic circuits such as an all-solid-state battery and a charging circuit can be mounted on a printed circuit board by a reflow process. The printed circuit board is an example of a battery module and may be a portable card type mobile battery.

FIG. 13 illustrates an example of a configuration of a printed circuit board 1201. The printed circuit board 1201 includes a substrate 1202, an all-solid-state battery 1203 provided on one side of the substrate 1202, a charge and discharge control integrated circuit (IC) 1204, a battery protection IC 1205, a battery remaining quantity monitoring IC 1206, and a universal serial bus (USB) interface 1207. Here, although an example in which the printed circuit board 1201 is a single-sided board will be described, the printed circuit board 1201 may be a double-sided board. Further, the printed circuit board 1201 may be a multilayer substrate or a buildup substrate.

The substrate 1202 is, for example, a rigid substrate. The all-solid-state battery 1203 is a battery according to any one of the first and second embodiments and the modified examples thereof. The charge and discharge control IC 1204 is a control unit which controls a charge and discharge operation of the all-solid-state battery 1203. The battery protection IC 1205 is a control unit that controls the charge and discharge operation to prevent a charge voltage from being excessive during charging and discharging, or an overcurrent from flowing or an overdischarge from occurring due to a load short circuit. The battery remaining quantity monitoring IC 1206 is a monitoring unit which monitors the battery remaining amount of the all-solid-state battery 1203 and notifies a load (for example, host device) 1209 and the like of the battery remaining amount.

The all-solid-state battery 1203 is charged by power supplied from an external power supply or the like via the USB interface 1207. A predetermined power (for example, a voltage of 4.2 V) is supplied from the all-solid-state battery 1203 to the load 1209 via load connection terminals 1208a and 1208b. Note that the USB interface 1207 may be used for connection to the load.

Specific examples of the load 1209 include wearable devices (sports watch, watch, hearing aid, and the like), IoT terminals (sensor network terminal and the like), amusement devices (portable game terminal, game controller), IC board embedded batteries (real time clock IC), environmental power generation devices (storage element for power generation elements such as photovoltaic power generation, thermoelectric power generation, and vibration power generation) and the like.

“Universal Credit Card as Application Example”

Hereinafter, an application example in which the present disclosure is applied to a universal credit card will be described.

The universal credit card is a card in which functions such as a plurality of credit cards or point cards are integrated into one card. In this card, for example, information such as numbers and expiration dates of various credit cards and point cards can be incorporated, if a user puts the one universal credit card in his/her wallet, the user can choose and use cards whenever and whatever the user wants.

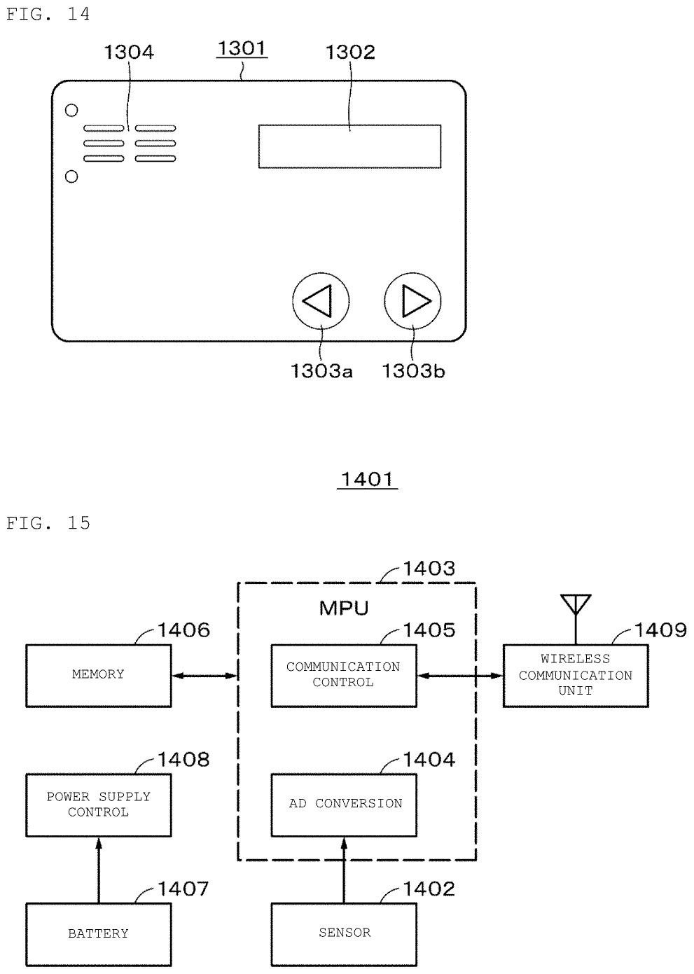

FIG. 14 illustrates an example of a configuration of a universal credit card 1301. The universal credit card 1301 has a card type shape and includes an IC chip and an all-solid-state battery (not illustrated) provided therein. In addition, the universal credit card 1301 has a low-power-consumption display 1302 mounted on one surface thereof, direction keys 1303a and 1303b as an operation unit, and a charging terminal 1304. The all-solid-state battery is a battery according to any one of the first and second embodiments and the modified examples thereof.

For example, the user can operate the direction keys 1303a and 1303b while looking at the display 1302 to designate a desired one of a plurality of credit cards loaded on the universal credit card 1301 in advance. The designated credit card can be used in the same manner as a conventional credit card. The above is an example, and it goes without saying that the battery according to any of the first and second embodiments and the modified examples thereof can be applied to all electronic cards other than the universal credit card 1301.

“Sensor network terminal as application example”

Hereinafter, an application example in which the present disclosure is applied to a sensor network terminal will be described.

A wireless terminal in a wireless sensor network is called a sensor node, and is configured by one or more wireless chips, a microprocessor, a power supply (battery), and the like. A specific example of the sensor network is used to monitor energy saving management, health management, industrial measurement, traffic conditions, agriculture and the like. As a type of sensors, voltage, temperature, gas, illuminance or the like is used.

In the case of the energy saving management, as a sensor node, a power monitor node, a temperature/humidity node, an illuminance node, a CO₂ node, a human touch node, a remote control node, a router (repeater) and the like are used. These sensor nodes are provided to configure a wireless network in homes, office buildings, factories, shops, amusement facilities, and the like.

Then, data such as temperature, humidity, illuminance, CO₂ concentration, and electric energy are displayed, and the conditions of energy saving of the environment can be seen. Furthermore, on/off control for lighting, air conditioning facilities, ventilation facilities and the like is performed by a command from a control station.

ZigBee (registered trademark) can be used as one of wireless interfaces of the sensor network. The wireless interface is one of short distance wireless communication standards, and has characteristics that it has a short transferable distance and a low transfer rate but is inexpensive and consumes low power. Therefore, it is suitable for mounting on a battery-driven device. A basic part of the communication standards is standardized as IEEE 802.15.4. Communication protocols between devices above a logical layer are being formulated by the ZigBee (registered trademark) Alliance.

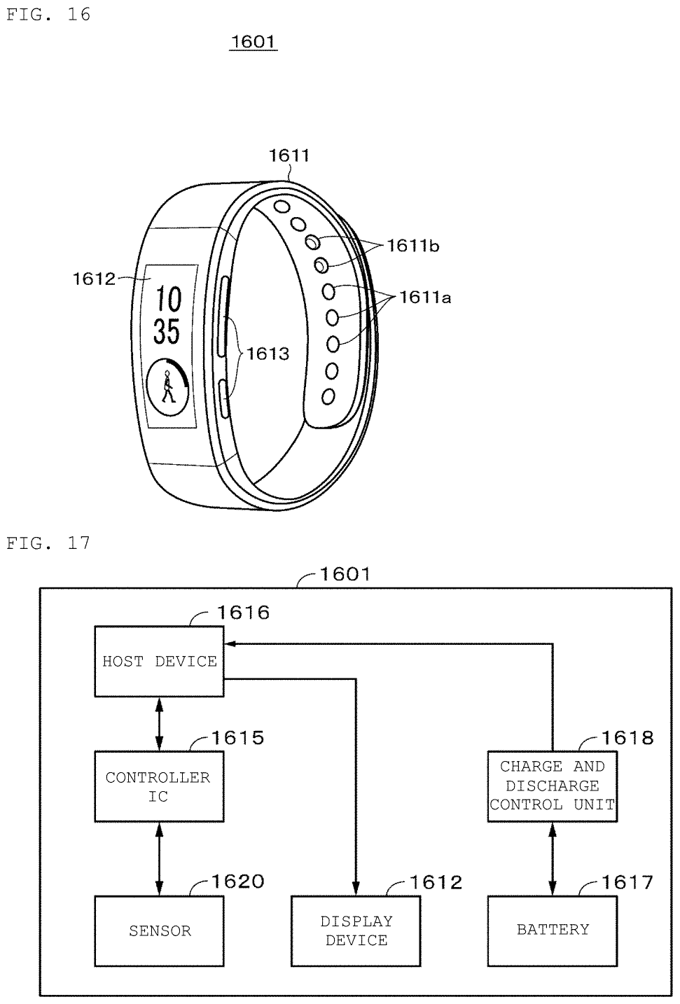

FIG. 15 illustrates an example of a configuration of a wireless sensor node 1401. A detection signal of a sensor 1402 is supplied to an AD conversion circuit 1404 of a microprocessor (MPU) 1403. Various sensors described above can be used as the sensor 1402. A memory 1406 is provided in association with the microprocessor 1403. In addition, an output of the battery 1407 is supplied to a power control unit 1408, and power of the sensor node 1401 is managed. The battery 1407 is a battery according to any one of the first and second embodiments and the modified examples thereof.

A program is installed on the microprocessor 1403. The microprocessor 1403 processes data on the detection results of the sensor 1402 output from the AD conversion circuit 1404 according to the program. A wireless communication unit 1409 is connected to the communication control unit 1405 of the microprocessor 1403, and the data on the detection results from the wireless communication unit 1409 are transmitted to a network terminal (not illustrated) using, for example, ZigBee (registered trademark) and connected to the network via the network terminal. A predetermined number of wireless sensor nodes can be connected to one network terminal. Note that as the form of the network, forms such as a tree type, a mesh type, and a linear type, in addition to a star type can be used.

“Wristband type electronic device as application example”

Hereinafter, an application example in which the present disclosure is applied to a wristband type electronic device will be described.

The wristband type electronic device is also called a smart band, and is wound only around an arm and as a result can acquire data on human activities such as the number of steps, moving distance, calories burned, sleep amount, and heart rate. Furthermore, the acquired data can also be managed by a smartphone. Furthermore, the wristband type electronic device can include a mail transmitting/receiving function, and for example, can notify a user of an arrival of mail by a light emitting diode (LED) lamp and/or vibration.

FIG. 16 illustrates an example of an appearance of a wristband type electronic device 1601. The electronic device 1601 is a so-called wearable device of a wrist watch type which is detachable from the human body. The electronic device 1601 includes a band portion 1611 attached on an arm, a display device 1612 which displays numbers, characters, patterns, and the like, and an operation button 1613. The band portion 1611 is provided with a plurality of hole portions 1611a and protrusions 1611b provided on an inner circumferential surface (surface on a side which contacts the arm when the electronic device 1601 is attached) thereof.

When the electronic device 1601 is in a use state, the electronic device 1601 is worn on an arm by curving the band portion 1611 so that the band portion 1611 is substantially circular as illustrated in FIG. 16 and inserting the protrusions 1611b into the hole portions 1611a. By adjusting the position of the hole portion 1611a into which the protrusion 1611b is inserted, a size of a diameter can be adjusted according to the thickness of the arm. When the electronic device 1601 is not used, the protrusion 1611b is removed from the hole portion 1611a, and the band portion 1611 keeps substantially flat. A sensor (not illustrated) is provided inside the band portion 1611 substantially over the whole of the band portion 1611.

FIG. 17 illustrates an example of a configuration of the electronic device 1601. The electronic device 1601 includes a controller IC 1615 as a drive control unit, a sensor 1620, a host device 1616, a battery 1617 as a power source, and a charge and discharge control unit 1618, in addition to the display device 1612 described above. The sensor 1620 may include the controller IC 1615.

The sensor 1620 can detect both pressing and bending. The sensor 1620 detects a change in capacitance according to the pressing, and outputs an output signal according to the change to the controller IC 1615. In addition, the sensor 1620 detects a change in a resistance value (change in resistance) according to the bending, and outputs an output signal according to the change to the controller IC 1615. The controller IC 1615 detects the pressing and bending of the sensor 1620 based on the output signal from the sensor 1620, and outputs information corresponding to the detection result to the host device 1616.

The host device 1616 executes various pieces of processing based on the information supplied from the controller IC 1615. For example, processing such as display of character information and image information on the display device 1612, movement of a cursor displayed on the display device 1612, and scrolling of a screen are performed.

The display device 1612 is, for example, a flexible display device, and displays a video (screen) based on a video signal or a control signal supplied from the host device 1616. Examples of the display device 1612 include a liquid crystal display, an electro luminescence (EL) display, an electronic paper, and the like, but are not limited thereto.

The battery 1617 is a battery according to any one of the first and second embodiments and the modified examples thereof. The charge and discharge control unit 1618 controls the charge and discharge operation of the battery 1617. Specifically, the charging of the battery 1617 from an external power supply or the like is controlled. In addition, the supply of power from the battery 1617 to the host device 1616 is controlled.

“Smart watch as application example”

Hereinafter, an application example in which the present disclosure is applied to a smart watch will be described.

The smart watch has the same or similar appearance as a design of the existing wrist watch, is used by being worn on a user's arm like the wrist watch, and has a function of notifying a user of various messages such as arrival of a telephone call or an electronic mail by information displayed on a display. In addition, the smart watch may have functions such as an electronic money function and an activity meter, and may have a function of performing near field communications such as a communication terminal (smartphone and the like) and Bluetooth (registered trademark).

(Overall Configuration of Smart Watch)

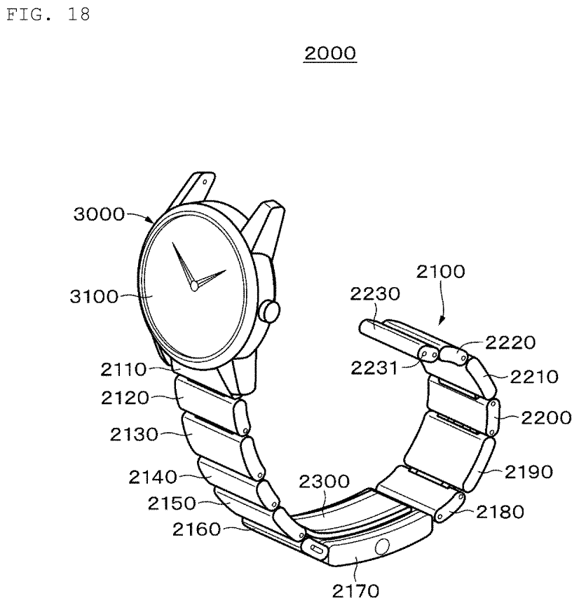

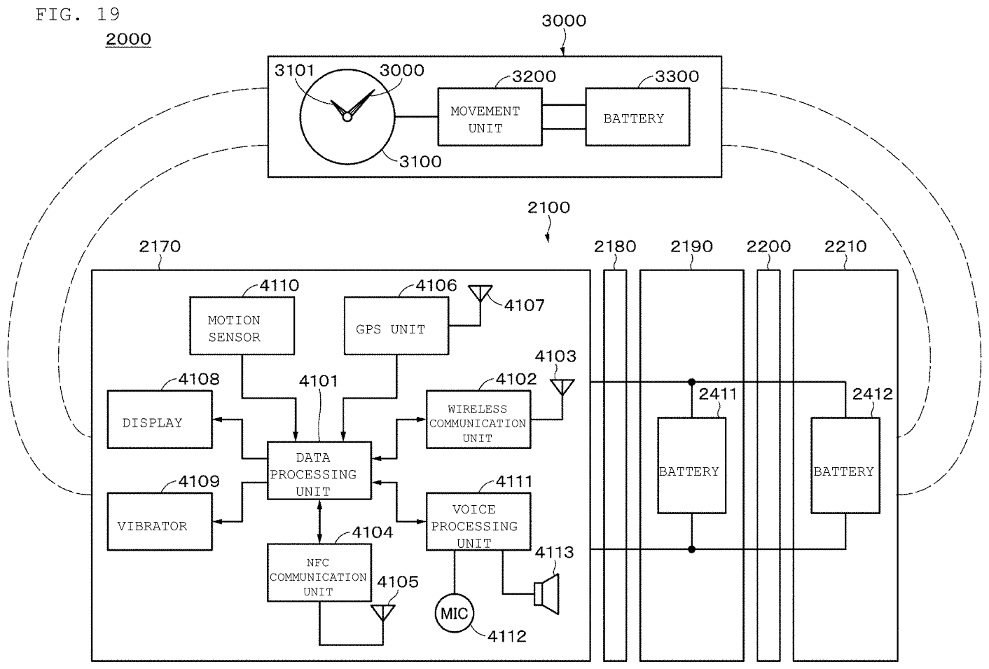

FIG. 18 illustrates an example of a configuration of a smart watch 2000. The smart watch 2000 includes a watch main body 3000 and a band type electronic device 2100. The watch main body 3000 includes a dial 3100 for displaying time. The watch main body 3000 may electrically display time on a liquid crystal display or the like instead of the dial 3100.

The band type electronic device 2100 is a metal band attached to the watch main body 3000, and worn on a user's arm. The band type electronic device 2100 has a configuration in which a plurality of segments 2110 to 2230 are connected. The segment 2110 is attached to one band attachment hole of the watch main body 3000, and the segment 2230 is attached to the other band attachment hole of the watch main body 3000. Each of the segments 2110 to 2230 is formed of metal.

Although FIG. 18 illustrates that the watch main body 3000 and the segment 2230 are a separated state in order to explain an example of the configuration of the band type electronic device 2100, the segment 2230 is attached to the watch main body 3000 in actual use. By attaching the segment 2230 to the watch main body 3000, the smart watch 2000 can be worn on a user's arm like a normal wrist watch. Connection parts of each of the segments 2110 to 2230 can be moved. Since the connection parts of the segments can be moved, the band type electronic device 2100 can be fitted to a user's arm.

A buckle portion 2300 is disposed between the segment 2170 and the segment 2160. The buckle portion 2300 extends long when a lock is unlocked and becomes short when the lock is locked. Each segment 2110 to 2230 is configured to have a plurality of types of sizes.

(Circuit Configuration of Smart Watch)

FIG. 19 illustrates an example of a circuit configuration of the band type electronic device 2100. An internal circuit of the band type electronic device 2100 has a configuration independent of the watch main body 3000. The watch main body 3000 includes a movement unit 3200 which rotates a needle disposed on the dial 3100. A battery 3300 is connected to the movement unit 3200. The movement unit 3200 or the battery 3300 is incorporated in a housing of the watch main body 3000. The battery 3300 is a battery according to any one of the first and second embodiments and the modified examples thereof.

Electronic components and the like are disposed in three segments 2170, 2190 and 2210 among the segments 2110 to 2230. A data processing unit 4101, a wireless communication unit 4102, an NFC communication unit 4104, and a GPS unit 4106 are disposed in the segment 2170. Antennas 4103, 4105, and 4107 are connected to the wireless communication unit 4102, the NFC communication unit 4104, and the GPS unit 4106, respectively. Each antenna 4103, 4105, and 4107 is disposed in the vicinity of a slit (not illustrated) of the segment 2170.

The wireless communication unit 4102 performs near field wireless communication with another terminal according to, for example, the Bluetooth (registered trademark) standard. The NFC communication unit 4104 performs wireless communication with a reader/writer close to each other according to the NFC standard. The GPS unit 4106 is a positioning unit which receives radio waves from satellites of a system called a global positioning system (GPS) and measures a current position. Data obtained by the wireless communication unit 4102, the NFC communication unit 4104, and the GPS unit 4106 are supplied to the data processing unit 4101.

A display 4108, a vibrator 4109, a motion sensor 4110, and a voice processing unit 4111 are disposed in the segment 2170. The display 4108 and the vibrator 4109 function as a notification unit which notifies a wearer of the band type electronic device 2100. The display 4108 is configured by a plurality of light emitting diodes, and notifies a user by lighting or flickering the light emitting diodes. The plurality of light emitting diodes are disposed, for example, inside a slit (not illustrated) of the segment 2170, and the arrival of a telephone call, the reception of an electronic mail, or the like is notified by lighting or flickering the light emitting diodes. The display 4108 may be a type in which characters, numbers, and the like are displayed. The vibrator 4109 is a member for vibrating the segment 2170. The band type electronic device 2100 notifies arrival of a telephone call, reception of an electronic mail or the like by causing the vibrator 4109 to vibrate the segment 2170.

The motion sensor 4110 detects movement of a user wearing the smart watch 2000. As the motion sensor 4110, an acceleration sensor, a gyro sensor, an electronic compass, an atmospheric pressure sensor or the like is used. In addition, the segment 2170 may also include a sensor other than the motion sensor 4110. For example, a biosensor which detects a pulse or the like of a user wearing the smart watch 2000 may be incorporated. The microphone 4112 and the speaker 4113 are connected to the voice processing unit 4111, and the voice processing unit 4111 performs processing on a call with the other party connected in a wireless communication scheme by the wireless communication unit 4102. In addition, the voice processing unit 4111 can also perform processing for a voice input operation.

A battery 2411 is incorporated in the segment 2190, and a battery 2421 is incorporated in the segment 2210. The batteries 2411 and 2421 supply driving power to circuits in the segment 2170. The circuit in the segment 2170 and the batteries 2411 and 2421 are connected to each other by a flexible circuit board (not illustrated). Although not illustrated in FIG. 19, the segment 2170 includes a terminal for charging the batteries 2411 and 2421. In addition, electronic components other than the batteries 2411 and 2421 may be disposed in the segments 2190 and 2210. For example, the segments 2190 and 2210 may be provided with a circuit which controls the charging and discharging of the batteries 2411 and 2421. The batteries 2411 and 2421 are batteries according to any one of the first and second embodiments and the modified examples thereof.

“Glasses type terminal as application example”

Hereinafter, an application example in which the present disclosure is applied to a glasses type terminal represented by one type of head mounted display (HMD) will be described.

The glasses type terminal described below can display information such as texts, symbols, and images which are superimposed on a scenery in front of eyes. That is, a lightweight and thin image display device display module dedicated to a transmissive glasses type terminal is mounted.

This image display device is configured by an optical engine and a hologram light guide plate. The optical engine uses a micro-display lens to emit image light such as images, texts and the like. This image light is incident on the hologram light guide plate. Since the hologram light guide plate has hologram optical elements incorporated at both ends of a transparent plate, the image light from the optical engine is propagated through a very thin transparent plate like a thickness of 1 mm and thus is observed by observer's eyes. With such a configuration, a lens (including a protection plate in front of and behind the light guide plate) having a thickness of 3 mm which has a transmittance of, for example, 85% is realized. Such a glasses type terminal enables a player, a team's performance and the like to be observed in real time while watching sports, and a tourist guide on a tour site can be displayed.

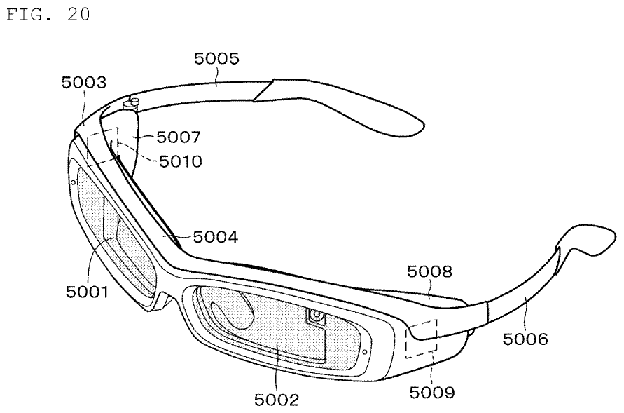

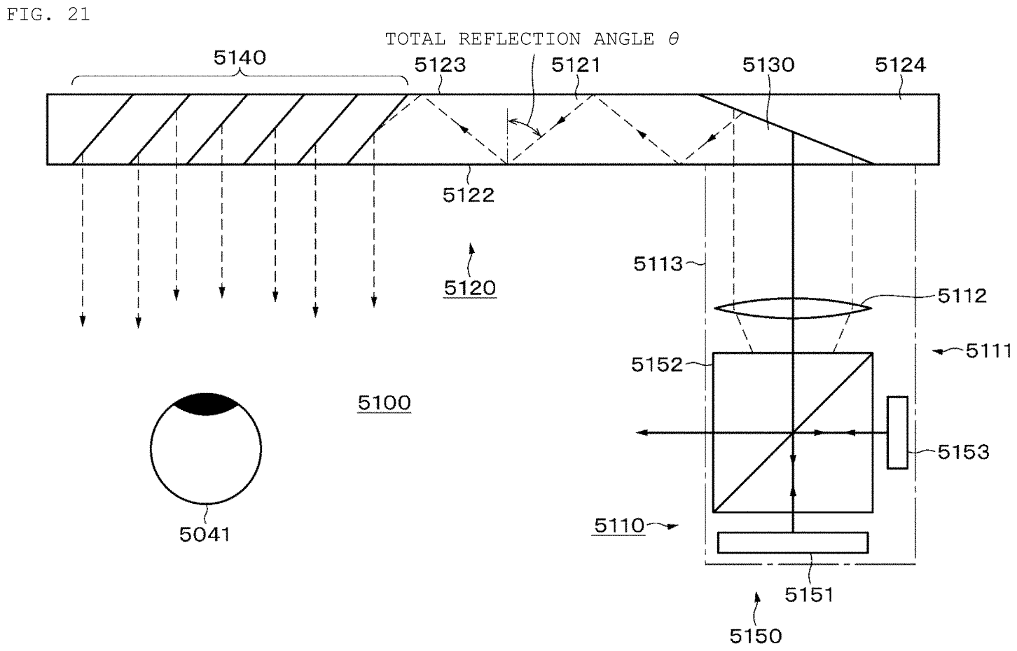

A specific example of the glasses type terminal includes one in which an image display unit is configured as a glasses type as illustrated in FIG. 20. That is, like normal glasses, the glasses type terminal is provided with a frame 5003 for holding a right image display unit 5001 and a left image display unit 5002 in front of eyes. The frame 5003 includes a front portion 5004 disposed in front of an observer, and two temple portions 5005 and 5006 rotatably attached to both ends of the front portion 5004 by a hinge. The frame 5003 is formed of the same material as that constituting the normal glasses, such as metal, alloy, plastic, or a combination thereof. Note that a headphone unit may be provided.

The right image display unit 5001 and the left image display unit 5002 are disposed to be located in front of a user's right eye and in front of a user's left eye, respectively. The temple portions 5005 and 5006 hold the right image display unit 5001 and the left image display unit 5002 on a user's head. The right display drive unit 5007 is disposed inside the temple portion 5005 at the connection part between the front portion 5004 and the temple portion 5005. The left display drive unit 5008 is disposed inside the temple portion 5006 at the connection part between the front portion 5004 and the temple portion 5006.

Batteries 5009 and 5010 are provided on the frame 5003. The batteries 5009 and 5010 are batteries according to any one of the first and second embodiments and the modified examples thereof. Although omitted in FIG. 20, the frame 5003 is provided with an acceleration sensor, a gyro, an electronic compass, a microphone/speaker, and the like. Furthermore, the frame 5003 is provided with an imaging device to be capable of shooting a still image/moving image. Furthermore, the frame 5003 is provided with a controller connected to the glasses unit by, for example, a wireless or wired interface. The controller is provided with a touch sensor, various buttons, a speaker, a microphone, and the like. Furthermore, the frame 5003 has a cooperation function with a smartphone. For example, it is possible to provide information according to the user's situation by utilizing the GPS function of the smartphone. Hereinafter, the image display apparatus (the right image display unit 5001 or the left image display unit 5002) will be mainly described.

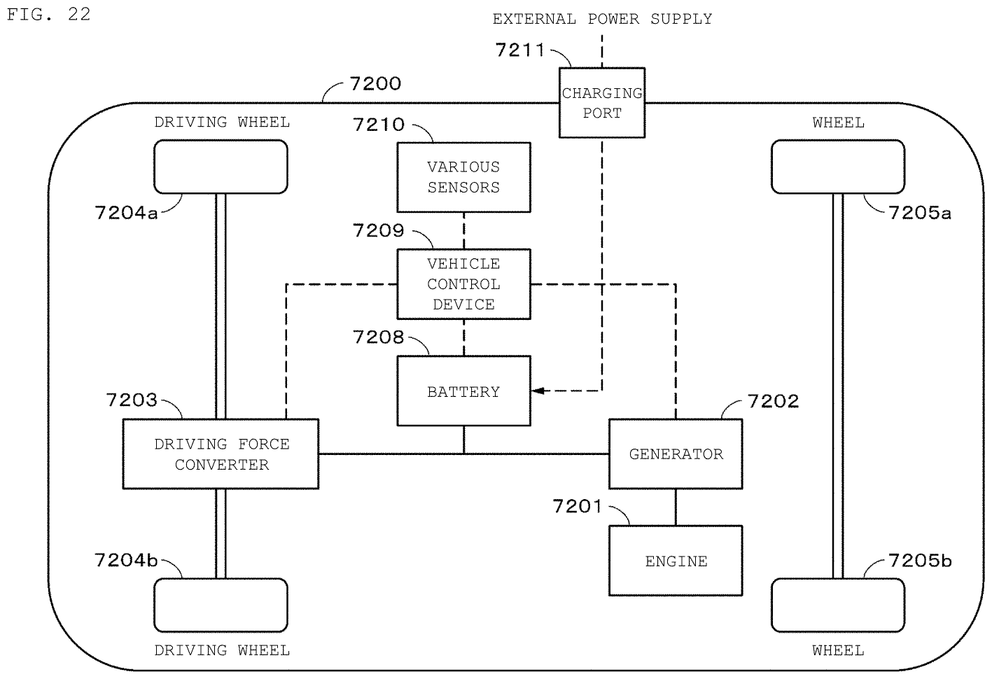

FIG. 21 illustrates an example of a configuration of an image display device (right image display unit 5001 or left image display unit 5002) of the glasses type terminal. The image display device 5100 includes an image generation device 5110 and an optical device (light guide unit) 5120 which gets light emitted from the image generation device 5110 to be incident and guided thereinto and emits the light toward a pupil 5041 of an observer. The optical device 5120 is attached to the image generation device 5110.

The optical device 5120 is an optical device having a first configuration, and includes a light guide plate 5121 through which light incident from the image generation device 5110 is propagated by total reflection and is then emitted toward the pupil 5041 of the observer, a first deflector 5130 which deflects the light incident on the light guide plate 5121 so that the light incident on the light guide plate 5121 is totally reflected inside the light guide plate 5121, and a second deflector 5140 which deflects the light propagated by the total reflection in the light guide plate 5121 plural times in order to emit light, which is propagated by total reflection in the light guide plate 5121, from the light guide plate 5121.

The first deflector 5130 and the second deflector 5140 are disposed inside the light guide plate 5121. Then, the first deflector 5130 reflects the light incident on the light guide plate 5121, and the second deflector 5140 transmits and reflects the light propagated by the total reflection in the light guide plate 5121 plural times. That is, the first deflector 5130 functions as a reflecting mirror, and the second deflector 5140 functions as a semitransparent mirror. More specifically, the first deflector 5130 provided inside the light guide plate 5121 is formed of aluminum, and is constituted by a light reflection film (a kind of mirror) which reflects the light incident on the light guide plate 5121. On the other hand, the second deflector 5140 provided inside the light guide plate 5121 is constituted by a multilayer laminated structure in which a large number of dielectric laminated films are laminated. The dielectric laminated film is constituted by, for example, a TiO₂ film as a high dielectric constant material and an SiO₂ film as a low dielectric constant material.

A flake formed of the same material as that of the light guide plate 5121 is sandwiched between the dielectric laminated films. In the first deflector 5130, parallel light incident on the light guide plate 5121 is reflected (or diffracted) so that the parallel light is totally reflected inside the light guide plate 5121. On the other hand, in the second deflector 5140, the parallel light propagated by the total reflection in the light guide plate 5121 is reflected (or diffracted) plural times and emitted from the light guide plate 5121 in the state of parallel light.

The light guide plate 5121 is provided with an inclined surface on which the first deflector 5130 is to be formed by cutting out a portion 5124 provided with the first deflector 5130 of the light guide plate 5121, and after the light reflection film is provided on the inclined surface by vacuum deposition, the cut-out portion 5124 of the light guide plate 5121 may be bonded to the first deflector 5130. Further, in the second deflector 5140, the multilayer laminated structure in which the same material (for example, glass) as the material constituting the light guide plate 5121 and the dielectric laminated film (for example, film formation can be performed by the vacuum evaporation) is stacked in plural is produced, the inclined surface is formed by cutting out a portion 5125 provided with the second deflector 5140 of the light guide plate 5121, and the inclined surface is bonded to the multilayer laminated structure and subjected to polishing and the like to arrange an appearance. By doing so, the optical device 5120 in which the first deflector 5130 and the second deflector 5140 are provided inside the light guide plate 5121 can be obtained.

The light guide plate 5121 formed of optical glass or a plastic material is provided with two parallel surfaces (a first surface 5122 and a second surface 5123) extending in parallel with an axis of the light guide plate 5121. The first surface 5122 and the second surface 5123 face each other. Then, parallel light is incident from the first surface 5122 corresponding to the light incident surface, propagates in the inside by total reflection, and then is emitted from the first surface 5122 corresponding to the light emitting surface.

In addition, the image generation device 5110 is constituted by the image generation device of the first configuration, and includes an image forming device 5111 which has a plurality of pixels arranged in a two-dimensional matrix form and a collimating optical system 5112 which emits the light emitted from each pixel of the image forming device 5111 as the parallel light.

Here, an image forming device 5111 includes a reflective spatial light modulator 5150 and a light source 5153 constituted by a light emitting diode for emitting white light. More specifically, the reflective spatial light modulator 5150 is configured by a liquid crystal display device (LCD) 5151, which is formed of liquid crystal on silicon (LCOS), as a light valve, and a polarization beam splitter 5152 which reflects a part of light from the light source 5153 and guides the reflected light to the liquid crystal display device 5151 and passes a part of the light reflected by the liquid crystal display device 5151 and guides the passed light to the collimating optical system 5112. The LCD is not limited to the LCOS type.

The liquid crystal display device 5151 includes a plurality (for example, 320×240) of pixels arranged in a two-dimensional matrix form. The polarization beam splitter 5152 has a known configuration and structure. The unpolarized light emitted from the light source 5153 collides with the polarization beam splitter 5152. In the polarization beam splitter 5152, a P-polarization component passes through and is emitted out of the system. On the other hand, an S-polarization component is reflected by the polarization beam splitter 5152, incident on the liquid crystal display device 5151, reflected inside the liquid crystal display device 5151, and emitted from the liquid crystal display device 5151. Here, among the light emitted from the liquid crystal display device 5151, light emitted from a pixel displaying “white” contains a large amount of P-polarization component, and light emitted from a pixel displaying “black” includes a large amount of S-polarization component. Accordingly, the P-polarization component of the light emitted from the liquid crystal display device 5151 and colliding with the polarization beam splitter 5152 passes through the polarization beam splitter 5152 and is guided to the collimating optical system 5112.

On the other hand, the S-polarization component is reflected at the polarization beam splitter 5152 and returned to the light source 5153. The liquid crystal display device 5151 includes, for example, a plurality (for example, 320×240) of pixels (the number of liquid crystal cells is three times the number of pixels) arranged in a two-dimensional matrix form. The collimating optical system 5112 is constituted by, for example, a convex lens, and an image forming device 5111 (more specifically, a liquid crystal display device 5151) is disposed at a place (position) of a focal distance in the collimating optical system 5112 in order to generate parallel light. In addition, one pixel is constituted by a red light emission sub-pixel which emits red light, a green light emission sub-pixel which emits green light, and a blue light emission sub-pixel which emits blue light.

“Storage System in Vehicle as Application Example”

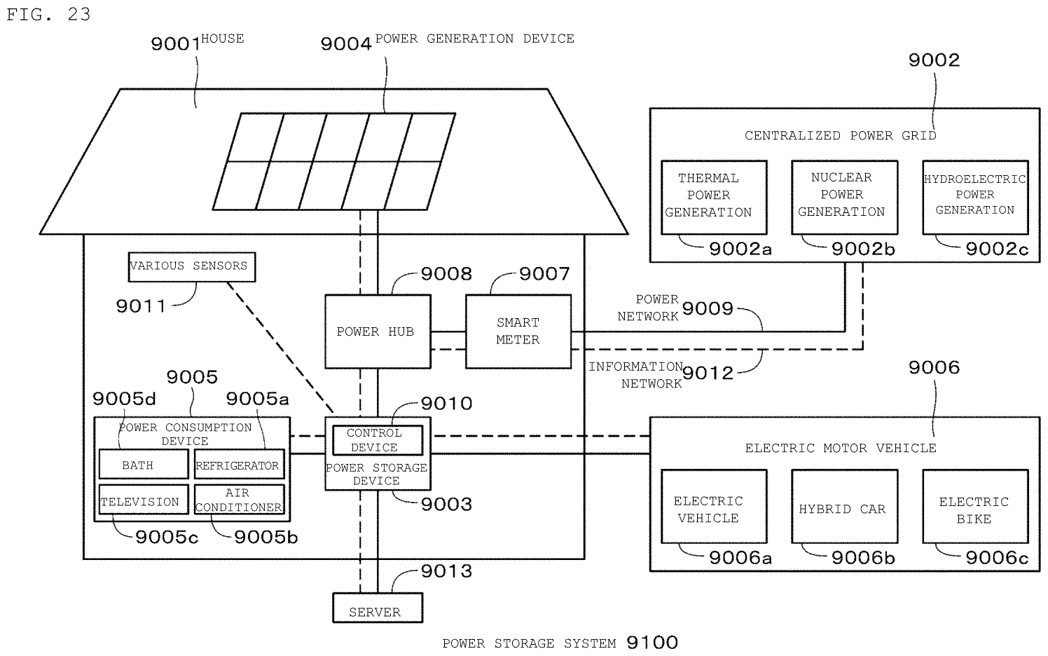

The example in which the present disclosure is applied to a storage system for a vehicle will be described with reference to FIG. 22. FIG. 22 schematically illustrates an example of a configuration of a hybrid car that employs a series hybrid system to which the present disclosure is applied. The series hybrid system is a vehicle which travels by a power and driving force converter which uses power generated by a generator driven by an engine or the power once stored in a battery.

A hybrid car 7200 includes an engine 7201, a generator 7202, a power and driving force converter 7203, a driving wheel 7204a, a driving wheel 7204b, a wheel 7205a, a wheel 7205b, a battery 7208, a vehicle control device 7209, various sensors 7210, a charging port 7211. The power storage device of the present disclosure described above is applied to the battery 7208.

The hybrid car 7200 travels using the power and driving force converter 7203 as a power source. An example of the power and driving force converter 7203 is a motor. The power and driving force converter 7203 is operated by the power of the battery 7208, and the rotational force of the power and driving force converter 7203 is transmitted to the driving wheels 7204a and 7204b. Note that by using direct current to alternating current (DC to AC) or reverse conversion (AC to DC conversion) at necessary places, the power and driving force converter 7203 can be applied to both an alternating current motor and a direct current motor. Various sensors 7210 control an engine speed and an opening degree (throttle opening degree) of a throttle valve (not illustrated) using the vehicle control device 7209. Various sensors 7210 include a speed sensor, an acceleration sensor, an engine speed sensor, and the like.

A rotational force of the engine 7201 is transmitted to the generator 7202, and the power generated by the rotational force in the generator 7202 can be stored in the battery 7208.

When the hybrid car is decelerated by a braking mechanism (not illustrated), a resistance force at the time of deceleration is applied as a rotational force to the power and driving force converter 7203, and regenerative power generated by the rotational force in the power and driving force converter 7203 is stored in battery 7208.

The battery 7208 is connected to a power supply outside the hybrid car and therefore the charging port 7211 as an input port can receive power from the external power supply, so the battery 7208 can store the received power.

Although not illustrated, an information processing apparatus performing information processing related to a vehicle control based on information on a secondary battery may be provided. Examples of the information processing apparatus include an information processing apparatus which displays a battery remaining quantity based on information on a battery remaining quantity.

In the above description, the series hybrid car traveling by a motor using the power generated by the generator driven by the engine or the power once stored in the battery has been described as an example. However, the present disclosure can effectively be applied to a parallel hybrid car in which both the outputs of the engine and the motor are drive sources, and thus three modes of traveling the parallel hybrid car only by the engine, traveling the parallel hybrid car only by the motor, and traveling the parallel hybrid car by the engine and the motor travel are appropriately switched and used. Furthermore, the present disclosure can be effectively applied to a so-called electric motor vehicle which travels only by a drive motor without using the engine.

The example of the hybrid car 7200 to which the technology according to the present disclosure can be applied has described above. The technology according to the present disclosure can be suitably applied to the battery 7208 among the configurations described above.

“Storage System for House as Application Example”

The example in which the present disclosure is applied to a storage system for a house will be described with reference to FIG. 23. For example, in a storage system 9100 for a house 9001, power is supplied from centralized power grid 9002 such as thermal power generation 9002a, nuclear power generation 9002b, and hydroelectric power generation 9002c and the like to a power storage device 9003 via a power network 9009, an information network 9012, a smart meter 9007, a power hub 9008 and the like. At the same time, power is supplied to the power storage device 9003 from an independent power supply such as a household power generation device 9004. Power supplied to the power storage device 9003 is stored. The power storage device 9003 is used to supply power used in a house 9001. The same storage system can be used not only for the house 9001 but also for a building.

The house 9001 is provided with a power generation device 9004, a power consumption device 9005, a power storage device 9003, a control device 9010 for controlling each device, a smart meter 9007, and a sensor 9011 for acquiring various information. Each of the devices are connected to each other by a power network 9009 and an information network 9012. A solar cell, a fuel cell, or the like is used as the power generation device 9004, and the generated power is supplied to the power consumption device 9005 and/or the power storage device 9003. The power consumption device 9005 is, for example, a refrigerator 9005a, an air conditioner 9005b, a television receiver 9005c, a bath 9005d and the like. Furthermore, the power consumption device 9005 includes an electric motor vehicle 9006. The electric motor vehicle 9006 is an electric vehicle 9006a, a hybrid car 9006b, and an electric bike 9006c.

The battery unit of the present disclosure described above is applied to the power storage device 9003. The power storage device 9003 is constituted by a secondary battery or a capacitor. For example, the power storage device 9003 is constituted by a lithium ion battery. The lithium ion battery may be a stationary type or may be used in the electric motor vehicle 9006. The smart meter 9007 has a function of measuring a usage amount of commercial power and transmitting the measured usage amount to a power company. The power network 9009 may be one of direct current feed, alternating current feed, and non-contact feed or combinations thereof.

Various sensors 9011 are, for example, a human touch sensor, an illuminance sensor, an object detection sensor, a power consumption sensor, a vibration sensor, a contact sensor, a temperature sensor, an infrared sensor, and the like. Information acquired by various sensors 9011 is transmitted to the control device 9010. By the information from the sensor 9011, a state of weather, a state of a person and the like are understood, and the power consumption device 9005 can be automatically controlled to minimize energy consumption. Furthermore, the control device 9010 can transmit the information on the house 9001 to an external power company or the like via the Internet.

The power hub 9008 performs processing such as branching of power lines and DC/AC conversion. As a communication system of the information network 9012 connected to the control device 9010, there are a method of using communication interfaces such as universal asynchronous receiver-transmitter (UART: transmitter and receiver circuit for asynchronous serial communication), and a method of using a sensor network based on wireless communication standards such as Bluetooth (registered trademark), ZigBee (registered trademark), and Wi-Fi The Bluetooth (registered trademark) system is applied to multimedia communication, and can perform one-to-many connection communication. ZigBee uses a physical layer of Institute of Electrical and Electronics Engineers (IEEE) 802.15.4. IEEE 802.15.4 is a name of a short distance wireless network standard called a personal area network (PAN) or wireless (W) PAN.

The control device 9010 is connected to an external server 9013. The server 9013 may be managed by any one of a house 9001, a power company, and a service provider. The information transmitted and received by the server 9013 is, for example, power consumption information, life pattern information, power rates, weather information, natural disaster information, and information on power transactions. These pieces of information may be transmitted and received from a household power consumption device (for example, a television receiver), but may be transmitted and received from devices (for example, a mobile phone and the like) outside the home. These pieces of information may be displayed on devices having a display function, for example, a television receiver, a mobile phone, personal digital assistants (PDA), or the like.

The control device 9010 that controls each unit is constituted by a central processing unit (CPU), a random access memory (RAM), a read only memory (ROM), and the like, and is stored in the power storage device 9003 in this example. The control device 9010 is connected to the power storage device 9003, the household power generation device 9004, the power consumption device 9005, various sensors 9011, and the server 9013 via the information network 9012, and has a function of adjusting, for example, the usage amount of commercial power and the power generation amount. In addition, the control device 9010 may include a function, which performs transactions in an electric power market, and the like.

As described above, the power storage device 9003 may store the generated power of not only the centralized power grid 9002 such as the thermal power 9002a, the nuclear power 9002b, and the hydroelectric power 9002c but also the household power generation device 9004 (solar power generation, wind power generation). Therefore, even if the power generated by the household power generation device 9004 fluctuates, control can be performed so that the amount of power to be transmitted to the outside can be made constant, or the discharge can be performed as much as necessary. For example, a method of storing power obtained by a solar power generation in the power storage device 9003, and storing cheap off-peak electricity in night time in the power storage device 9003 and discharging electricity stored in the power storage device 9003 in the time zone of day time where an electricity charge is high can be used.

In this example, although the example in which the control device 9010 is stored in the power storage device 9003 has been described, the control device 9010 may be stored in the smart meter 9007 or may be configured alone. Furthermore, the power storage system 9100 may be used for a plurality of households in an apartment house, or may be used for a plurality of detached houses.

The example of the power storage system 9100 to which the technology according to the present disclosure can be applied has been described above. The technology according to the present disclosure can be suitably applied to the secondary battery of the power storage device 9003 among the configurations described above.

As mentioned above, although the embodiments and the modified examples of this technology, were described in detail, this technology is not limited to the embodiments and the modified examples thereof, and the Examples described above, but various modifications can be made based on the technical ideas of the present technology.

For example, the configurations, methods, processes, shapes, materials, numerical values, and the like described in the embodiments and the modified examples thereof, and Examples described above are merely examples, and different configurations, methods, processes, shapes, materials, numerical values, and the like may be used as needed. In addition, chemical formulas of compounds and the like are representative ones, and are not limited to the indicated valences and the like as long as they are common names of the same compounds.

In addition, the configurations, methods, processes, shapes, materials, numerical values, and the like of the embodiments and the modified examples thereof, and the examples described above can be combined with one another without departing from the spirit of the present technology.

In addition, the present technology is applicable to various electronic devices provided with a battery, and is not limited to the electronic devices described in the application examples described above. Examples of the electronic devices other than the application examples described above include a notebook personal computer, a tablet computer, mobile phones (for example, smart phone and the like), personal digital assistants (PDA), display devices (LCD, EL display, electronic paper, and the like), imaging devices (for example, digital still camera, digital video camera, and the like), audio devices (for example, portable audio player), a game machine, a cordless handset, an electronic book, an electronic dictionary, a radio, a headphones, a navigation system, a memory card, a pacemakers, a hearing aid, an electric tool, an electric shaver, a refrigerator, an air conditioner, a televisions, stereo, a water heater, a microwave oven, a dishwasher, a washing machine, a dryer, a lighting device, a toy, a medical device, a robot, a road conditioner, a traffic light, and the like, but are not limited thereto.

### DESCRIPTION OF REFERENCE SYMBOLS

11: Exterior battery element
11 SA: First end face
11SB: Second end face
12: Cathode terminal
13: Anode terminal
14: Exterior member
20: Battery element
21: Cathode
21A: Cathode current collection layer
21B: Cathode active material layer
22, 24: Anode
23: Solid electrolyte layer
24A: Anode current collecting layer
24B: Anode active material layer

1. An all-solid-state battery, comprising:
a cathode layer;
an anode layer that contains a carbon material, and a volume occupancy of the carbon material in the anode layer is 50 vol % to 95 vol %; and
a solid electrolyte layer between the cathode layer and the anode layer.

2. The all-solid-state battery according to claim 1, wherein
the carbon material is graphite, and
the anode layer has a single-layer structure that operates as both an anode active material layer and an anode current collecting layer.

3. The all-solid-state battery according to claim 1, wherein the carbon material contains at least one of graphite, acetylene black, ketjen black, and carbon fiber.

4. The all-solid-state battery according to claim 1, wherein the anode layer further contains a metal material.

5. The all-solid-state battery according to claim 1, wherein the metal material is a material that includes lithium, silicon, tin, aluminum, indium, magnesium, boron, gallium, germanium, lead, bismuth, cadmium, silver, zinc, hafnium, zirconium, yttrium, palladium, platinum, or one or more of alloys or compounds thereof.

6. The all-solid-state battery according to claim 1, wherein the anode layer includes
an anode active material layer containing a first carbon material, and
an anode current collecting layer containing a second carbon material, and
the first carbon material and the second carbon material are different types of carbon materials.

7. The all-solid-state battery according to claim 6, wherein a first volume occupancy of the first carbon material in the anode active material layer is 50 vol % to 95 vol %.

8. The all-solid-state battery according to claim 7, wherein a second volume occupancy of the second carbon material in the anode current collecting layer is 50 vol % to 95 vol %.

9. The all-solid-state battery according to claim 1, wherein the anode layer includes
an anode active material layer containing a first carbon material, and
an anode current collecting layer containing a second carbon material and a metal material, and
the first carbon material and the second carbon material are different types of carbon materials.

10. The all-solid-state battery according to claim 9, wherein a first volume occupancy of the first carbon material in the anode active material layer is 50 vol % to 95 vol %.

11. The all-solid-state battery according to claim 10, wherein a second volume occupancy of the second carbon material in the anode current collecting layer is 50 vol % to 95 vol %.

12. The all-solid-state battery according to claim 1, wherein the anode layer contains oxide glass containing Li or oxide glass ceramics containing Li.

13. The all-solid-state battery according to claim 12, wherein the oxide glass and the oxide glass ceramics contain at least one of germanium oxide, silicon oxide, boron oxide, phosphorus oxide, and lithium oxide.

14. The all-solid-state battery according to claim 1, wherein
the carbon material in the anode layer is a first carbon material,
the cathode layer includes a cathode active material layer and a cathode current collecting layer,
the cathode current collecting layer contains a second carbon material, and
a volume occupancy of the second carbon material in the cathode current collecting layer is 50 vol % to 95 vol %.

15. An electronic device containing the all-solid-state battery according to claim 1, and wherein the all-solid-state battery supplies power to the electronic device.

16. An electronic card containing the all-solid-state battery according to claim 1, and wherein the all-solid-state battery supplies power to the electronic card.

17. A wearable device containing the all-solid-state battery according to claim 1, and wherein the all-solid-state battery supplies power to the wearable device.

18. An electric motor vehicle comprising:
the all-solid-state battery according to claim 1;
a conversion device which is supplied with power from the all-solid-state battery and converts the power into a driving force for the electric motor vehicle; and
a control device which processes vehicle control information based on information regarding the all-solid-state battery.
